(19) United States
(12) Patent Application Publication
(10) Pub. No.: US 2022/0196151 A1
(43) Pub. Date: Jun. 23, 2022

(54) PISTON RING UNIT AND COMPRESSOR

(71) Applicant: KABUSHIKI KAISHA KOBE SEIKO SHO (KOBE STEEL, LTD.), Hyogo (JP)

(72) Inventors: Toru OKADA, Kobe-shi (JP); Tomohiro OTSUKA, Takasago-shi (JP)

(73) Assignee: KABUSHIKI KAISHA KOBE SEIKO SHO (KOBE STEEL, LTD.), Hyogo (JP)

(21) Appl. No.: 17/456,485

(22) Filed: Nov. 24, 2021

(30) Foreign Application Priority Data
Dec. 23, 2020 (JP) 2020-213063

(51) Int. Cl. F16J 9/26; F16J 15/28; F16J 9/08; F16J 15/00; F04B 53/14; F16J 15/24; F04B 15/08

(52) U.S. Cl. CPC F16J 9/26; F16J 15/28; F16J 9/08; F04B 15/08; F04B 53/143; F16J 15/24; F16J 15/006

(57) ABSTRACT

The piston ring unit includes a plurality of piston rings and an inner contact ring. A plurality of piston rings are disposed adjacent to each other in an axial direction of the piston such that joints of plurality of the piston rings do not overlap with each other in the axial direction. An inner contact ring is interposed between an outer circumferential surface of the piston and an inner circumferential surface of the piston ring in a state where the inner contact ring extends over all of the plurality of piston rings in the axial direction, and is disposed such that an opening of the inner contact ring does not overlap with the joint of the at least one piston ring as viewed in a radial direction of the piston.

### TECHNICAL FIELD

The present invention relates to a piston ring unit and a compressor.

### BACKGROUND ART

A compressor such as a reciprocating compressor is used to compress a gas. A reciprocating compressor, which is a type of compressor, includes: a cylinder; and a piston which performs a reciprocating motion in the cylinder in a cylinder axis direction of the cylinder. In the reciprocating compressor, in order to provide gas sealing between an inner circumferential surface of the cylinder and an outer circumferential surface of the piston, piston rings are mounted the outer circumferential surface of the piston.

JP 2015-40519A discloses a double-type piston ring mounted on an outer circumferential surface of a piston. The double-type piston ring disclosed in JP 2015-40519A includes two piston rings disposed adjacently to each other in an axial direction of the piston.

JP 2011-149310A discloses: a single-type piston ring mounted on an outer circumferential surface of a piston; and a tension ring interposed between the outer circumferential surface of the piston and an inner circumferential surface of the piston ring for biasing the outer circumferential surface of the piston ring against the inner circumferential surface of a cylinder.

The piston ring has a cut (joint) in a portion of the piston ring in a circumferential direction so that the piston ring can expand in a radial direction. Along with a reciprocating motion of the piston in the cylinder, the outer circumferential surface of the piston ring is worn. However, the piston ring is elastically biased outwardly in a radial direction from an inner circumferential surface by the tension ring so that a diameter of the piston ring is enlarged. Accordingly, sealing property between the outer circumferential surface of the piston ring and the inner circumferential surface of the cylinder is maintained.

The tension ring is disposed so as to close an joint of the piston ring from an inner circumferential surface side. Also with such a configuration, the sealing property between the piston and the cylinder is maintained.

### SUMMARY OF INVENTION

In the double-type piston ring disclosed in JP 2015-40519A, there is a case where the wear generated on the outer circumferential surface of the piston ring on a low-pressure side (a side opposite to a high-pressure side in the axial direction of the piston) progresses faster than the wear generated on the outer circumferential surface of the piston ring mounted on a high-pressure side (a side on which a pressure boosting chamber is disposed in the axial direction of the piston). To maintain the sealing property between the outer circumferential surface of the piston ring and the inner circumferential surface of the cylinder even when the piston ring mounted on the low-pressure side is worn, it is also conceivable to mount the tension ring disclosed in JP 2011-149310A on an inner circumferential side of the piston ring mounted on the low-pressure side.

However, even if the tension ring is mounted on the inner circumferential side of the piston ring on the low-pressure side as described above, it is difficult to prevent gas leakage from the high-pressure side to the low-pressure side. Specifically, assuming that the tension ring is mounted on the inner circumferential side of the piston ring on the low-pressure side, the tension ring moves in the axial direction of the piston (the position of the tension ring is displaced) as the piston performs a reciprocating motion. As a result, a portion of the joint of the piston ring on the low-pressure side closed by the tension ring is opened on the inner circumferential surface side. Therefore, even if the tension ring disclosed in JP 2011-149310A is combined with the piston ring on the low-pressure side disclosed in JP 2015-40519A, it is considered difficult to ensure high sealing property.

The present invention has been made to overcome the drawbacks, and it is an object of the present invention to provide a piston ring unit and a compressor capable of preventing leakage of a pressurized fluid from a high-pressure side to a low-pressure side.

A piston ring unit according to one aspect of the present invention is mounted on an outer circumferential surface of a piston which performs a reciprocating motion in a cylinder in a cylinder axis direction of the cylinder. The piston ring unit according to the present aspect includes a plurality of piston rings and an inner contact ring. The plurality of piston rings each have a C-shape with a joint at a portion of each of the plurality of piston rings in a circumferential direction, and the plurality of piston rings are mounted on the outer circumferential surface of the piston in a state where the plurality of piston rings are disposed adjacent to each other in an axial direction of the piston and mount on an inner circumferential surface of the cylinder.

The inner contact ring has a C-shape as viewed in the axial direction with an opening in a portion of the inner contact ring in the circumferential direction, is interposed between an outer circumferential surface of the piston and inner circumferential surfaces of the plurality of piston rings, and in contacts with an inner circumferential surface of at least one of the plurality of piston rings.

In the present aspect, the plurality of piston rings are disposed adjacent to each other in axial direction such that the joints of the plurality of piston rings do not overlap with each other in the axial direction. In the present aspect, the inner contact ring is disposed over all of the plurality of piston rings in the axial direction. The inner contact ring is disposed such that the opening does not overlap with the joint of the at least one piston ring as viewed in a radial direction of the piston.

According to another aspect of the present invention, a piston ring unit is mounted on a piston which performs a reciprocating motion in the cylinder in a cylinder axis direction of the cylinder. The piston has an annular groove which is recessed inwardly in a radial direction and is formed annularly in a circumferential direction. The piston ring unit according to the present aspect includes a plurality of piston rings and an inner contact ring.

The plurality of piston rings each have a C-shape with a joint at a portion of each of the plurality of piston rings in a circumferential direction. Further, the plurality of piston rings are mounted on a groove bottom surface of the annular groove of the piston in a state where the plurality of piston rings are disposed adjacent to each other in the axial direction, and mount on an inner circumferential surface of the cylinder.

The inner contact ring has a C-shape as viewed in the axial direction with an opening in a portion of the inner contact ring in the circumferential direction, and is interposed between the groove bottom surface of the piston and an inner circumferential surface of at least one piston ring among the plurality of piston rings. The inner contact ring in contacts with the inner circumferential surface of the at least one piston ring.

In the present aspect, the plurality of piston rings are disposed such that the joints of the plurality of piston rings disposed adjacent to each other in the axial direction in a plan view as viewed in the axial direction do not overlap with each other. The inner contact ring is disposed over the at least one piston ring in the axial direction. Further, the inner contact ring is disposed such that the opening does not overlap with all joints of at least one piston ring as viewed in a radial direction which is orthogonal to the axial direction.

A side at which a pressure boosting chamber is formed in the cylinder is set as a high-pressure side, and a side opposite to the high-pressure side is set as a low-pressure side in the axial direction. The at least one piston ring is disposed closer to the low-pressure side than remaining piston rings in the plurality of piston rings, and an inner diameter of the at least one piston ring is larger than an inner diameter of the piston ring adjacent to the at least one piston ring on the high-pressure side. In the present aspect, the inner contact ring is configured such that an end surface of the inner contact ring on the high-pressure side in contacts with or close to the piston ring disposed adjacent to the high-pressure side, and an end surface of the inner contact ring on the low-pressure side in contact with or close to a groove side surface of the annular groove.

A compressor according to one aspect of the present invention includes: a cylinder; a piston configured to reciprocate in the cylinder in a cylinder axis direction of the cylinder; and a piston ring unit according to any one of the aspects which is mounted on an outer circumferential surface of the piston.

In the compressor according to the aspect, the piston ring unit according to any one of the aspects is mounted on the outer circumferential surface of the piston. Therefore, the compressors according to the aspects can achieve substantially the same advantageous effects as any of the piston ring units described above.

### BRIEF DESCRIPTION OF DRAWINGS

FIG. 1 is a cross-sectional view showing a configuration of a reciprocating compressor according to a first embodiment;

FIG. 2 is a front view showing a configuration of a piston that the reciprocating compressor includes;

FIG. 3A is a cross-sectional view showing a configuration of a piston ring unit;

FIG. 3B is a exploded perspective view showing a configuration of the piston ring unit;

FIG. 4 is a plan view illustrating a positional relationship between respective joints of a first piston ring and a second piston ring and an opening of a first inner contact ring in the piston ring unit;

FIG. 5A is a cross-sectional view showing a configuration of the piston ring unit according to the first embodiment;

FIG. 5B is a cross-sectional view showing a configuration of a piston ring unit according to a comparative example 1;

FIG. 5C is a cross-sectional view showing a configuration of a piston ring unit according to a comparative example 2;

FIG. 6 is a cross-sectional view showing a configuration of a piston ring unit according to a second embodiment;

FIG. 7A is a plan view showing an arrangement mode of a first piston ring and a second inner contact ring in a circumferential direction;

FIG. 7B is a plan view showing an arrangement mode of a second piston ring and the first inner contact ring in a circumferential direction;

FIG. 8A is a cross-sectional view showing a configuration of a piston ring unit according to a third embodiment;

FIG. 8B is a perspective view showing a configuration of an auxiliary ring;

FIG. 9A is a cross-sectional view showing a configuration of a piston ring unit disposed between a high-pressure end and a low-pressure end in the configuration of the piston ring unit mounted on a piston of a reciprocating compressor according to a fourth embodiment;

FIG. 9B is a cross-sectional view showing a configuration of a piston ring unit disposed at the high-pressure end and a piston ring unit disposed at the low-pressure end in the configuration of the piston ring unit mounted on the piston of the reciprocating compressor according to the fourth embodiment;

FIG. 10 is a cross-sectional view showing a piston ring unit mounted on a piston of a reciprocating compressor according to a fifth embodiment;

FIG. 11 is a cross-sectional view showing a configuration of a portion of a piston ring unit according to a modification 1;

FIG. 12A is a perspective view showing a structure of a first piston ring according to a modification 2;

FIG. 12B is a perspective view showing a structure of a second piston ring according to a modification 3;

FIG. 13A is a plan view showing a structure of a first piston ring according to a modification 4;

FIG. 13B is a plan view showing a structure of a second piston ring according to a modification 5;

FIG. 14A is a plan view showing a structure of a first piston ring in a structure of a piston ring according to a modification 6;

FIG. 14B is a plan view showing a structure of a second piston ring in the structure of the piston ring according to the modification 6; and

FIG. 15 is a plan view showing a structure of an auxiliary ring in a piston ring unit according to a modification 7.

### DESCRIPTION OF EMBODIMENTS

Hereinafter, embodiments for carrying out the present invention are described with reference to the drawings. The embodiments described hereinafter are embodiments for describing the present invention in an exemplifying manner, and the present invention is not limited to the following embodiments except for its essential configuration.

In the description made hereinafter, an “axial direction” indicates a direction along an axis of a piston, a “circumferential direction” indicates a direction around the axis of the piston in a plane orthogonal to the axis of the piston, and a “radial direction” indicates a direction orthogonal to the axis of the piston.

### First Embodiment

### 1. Configuration of Reciprocating Compressor 1

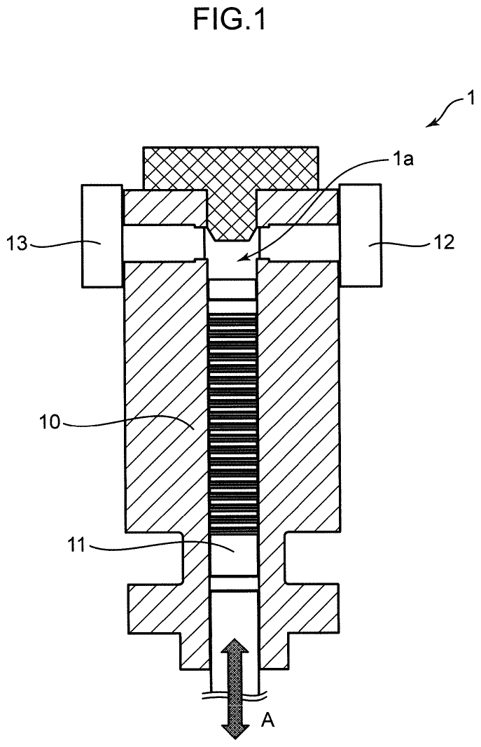

A configuration of a reciprocating compressor 1 according to a first embodiment is described with reference to FIG. 1. In FIG. 1, a portion of the configuration of the reciprocating compressor 1 according to the present embodiment is illustrated in an extracted manner.

As illustrated in FIG. 1, the reciprocating compressor 1 includes a cylinder 10, a piston 11, an inlet valve 12, and an outlet valve 13. The cylinder 10 has an inner space having a bottomed cylindrical shape. The piston 11 performs a reciprocating motion in the inner space of the cylinder 10 in a cylinder axis direction as indicated by an arrow A. A pressure boosting chamber 1a is fanned by one end surface (top surface) of the piston 11 and an inner wall surface of the cylinder 10.

A pressurized fluid (a hydrogen gas in the present embodiment as an example) is sucked into the pressure boosting chamber 1a along with the lowering of the piston 11. A hydrogen gas introduced into the pressure boosting chamber 1a is pressurized due to elevation (moving in an upward direction in FIG. 1) of the piston 11. When the piston 11 reaches a top dead center or a position in the vicinity of the top dead center so that a hydrogen gas is pressurized, the pressurized hydrogen gas is discharged through the outlet valve 13.

### 2. Piston 11 and Peripheral Members Around Piston 11

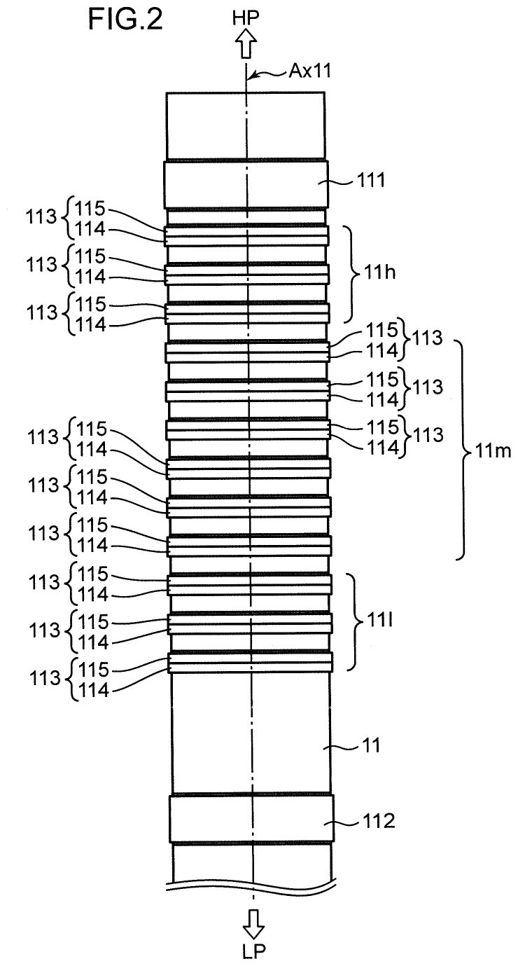

The piston 11 and the peripheral members around the piston 11 are described with reference to FIG. 2.

As illustrated in FIG. 2, two rider rings 111, 112 and a plurality of piston ring units 113 are mounted on an outer circumferential surface of the piston 11 having a circular columnar shape. The rider ring 111 is mounted on a portion of the piston 11 on a high-pressure HP side, and the rider ring 112 is mounted on a portion of the piston 11 on a low-pressure LP side. The high-pressure HP side is a side close to the pressure boosting chamber 1a (see FIG. 1) in the direction along the axis Ax11 of the piston 11 (axial direction). The low-pressure LP side is a side opposite to the high-pressure HP side in the direction along the axis Ax11 of the piston 11 (axial direction).

The rider rings 111, 112 are provided for centering the piston 11 toward the center of the cylinder 10 in the radial direction so as to prevent the piston 11 which performs a reciprocating motion in the cylinder 10 from generating axial runout.

The plurality of piston ring units 113 are mounted on the outer circumferential surface of the piston 11 in a state where the plurality of piston ring units 113 are spaced apart from each other in a direction along the axis Ax11 of the piston 11 (axial direction). Although the configuration of the plurality of piston ring units 113 will be described later, each piston ring unit has a first piston ring 114 and a second piston ring 115. In each piston ring unit 113, the first piston ring 114 and the second piston ring 115 are disposed in contact with each other in the axial direction.

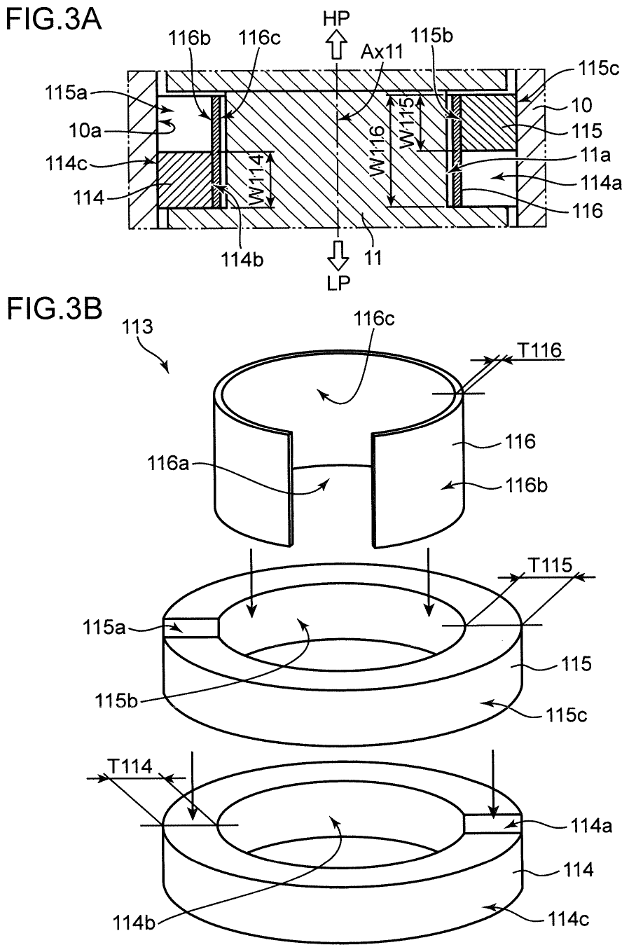

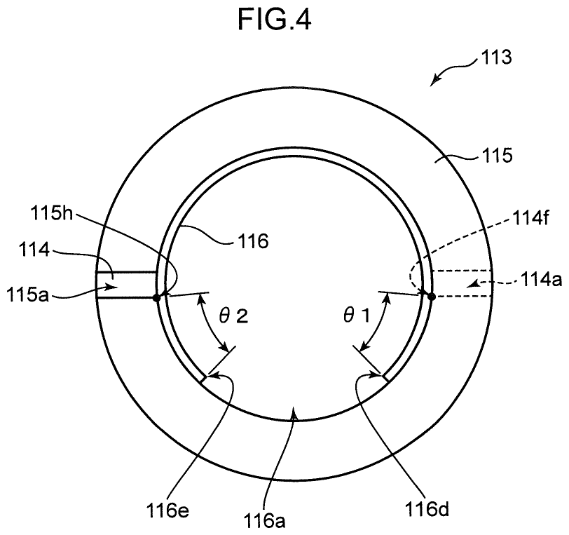

3. Configuration of piston ring unit 113 The configuration of the piston ring unit 113 according to the present embodiment will be described with reference to FIG. 3A, FIG. 3B, and FIG. 4.

As illustrated in FIG. 3A, FIG. 3B, and FIG. 4, the piston ring unit 113 according to the present embodiment includes the first piston ring 114, the second piston ring 115, and a first inner contact ring 116. As illustrated in FIG. 3A, the first piston ring 114, the second piston ring 115, and the first inner contact ring 116 constituting the piston ring unit 113 are fitted in an annular groove 11a annularly formed in the circumferential direction on the outer circumferential surface of the piston 11. In the present embodiment, in a space defined by the annular groove 11a, the first piston ring 114 is disposed on the low-pressure LP side, and the second piston ring 115 is disposed on the high-pressure HP side.

An outer circumferential portion of the first piston ring 114 and an outer circumferential portion of the second piston ring 115 protrude outward in the radial direction from the annular groove 11a. The outer circumferential surface 114c of the first piston ring 114 and the outer circumferential surface 115c of the second piston ring 115 mount on an inner circumferential surface 10a of the cylinder 10 in a gastight manner.

A groove bottom surface (an inner circumferential surface) of the annular groove 11a is an example of the “outer circumferential surface of the piston” in the present invention.

As illustrated in FIG. 3A, the first inner contact ring 116 has a plate width W116 in the direction along the axis Ax11 of the piston 11 (axial direction). The plate width W116 is set to be substantially equal to a size which is the sum of a thickness W114 of the first piston ring 114 and a thickness W115 of the second piston ring 115 in the axial direction. However, the plate width W116 may be larger than the thickness W114 and smaller than a size acquired by adding the thickness W114 and the thickness W115. As illustrated in FIG. 3A, the plate width W116 of the first inner contact ring 116 in the present embodiment is set to be slightly narrower than a groove width (a size in the axial direction) of the annular groove 11a in the axial direction. Further, the first inner contact ring 116 is provided such that a gap is formed between the groove bottom surface of the annular groove 11a and the first inner contact ring 116.

As illustrated in FIG. 3B, the first piston ring 114 has an joint 114a in a portion of the first piston ring 114 in the circumferential direction so that the first piston ring 114 has a C-shape in a plan view as viewed in the axial direction. In the same manner, the second piston ring 115 also has an joint 115a in a portion of the second piston ring 115 in the circumferential direction so that the second piston ring 115 has a C-shape in a plan view as viewed in the axial direction. The first inner contact ring 116 also has an opening 116a in a portion of the first inner contact ring 116 in the circumferential direction so that the first inner contact ring 116 has a C-shape in a plan view as viewed in the axial direction.

As illustrated in FIG. 4, the first piston ring 114 and the second piston ring 115 are disposed such that the joint 114a and the joint 115a are displaced from each other by half turn in the circumferential direction. That is, the first piston ring 114 and the second piston ring 115 are disposed such that the joint 114a and the joint 115a do not overlap with each other in a plan view as viewed in the axial direction. The first inner contact ring 116 is disposed such that the opening 116a of the first inner contact ring 116 does not overlap with the joints 114a and 115a in the radial direction. Specifically, both circumferential ends 116d and 116e of the first inner contact ring 116 which sandwich the opening 116a are circumferentially arranged so as to be displaced by approximately ⅛ turn (be displaced by θ1, θ2) with respect to the circumferential ends 114f and 115h close to the circumferential ends 116d and 116e among the circumferences sandwiching the joints 114a and 115a.

By disposing the first piston ring 114, the second piston ring 115, and the first inner contact ring 116 as described above, as illustrated in FIG. 3A, the joint 114a of the first piston ring 114 and the joint 115a of the second piston ring 115 are closed by the first inner contact ring 116 on the inner side in the radial direction. Therefore, it is possible to prevent the formation of a leakage path of a hydrogen gas from gaps formed between the groove bottom surface of the annular groove 11a and the inner circumferential surface of the first inner contact ring 116 and the respective joints 114a, 115a.

In the piston ring unit 113 according to the present embodiment, the first inner contact ring 116 has spring characteristics which expand a diameter of the inner contact ring 116 to the outside in the radial direction. Therefore, even if the outer circumferential surfaces 114c, 115c of the piston ring 114, 115 are worn due to sliding between the outer circumferential surfaces 114c, 115c and the inner circumferential surface 10a of the cylinder 10, the first inner contact ring 116 can maintain a contact state so as to follow the inner circumferential surfaces 114b, 115b of the piston rings 114, 115. Specifically, the first inner contact ring 116 is formed to be expandable in the radial direction to a diameter equal to or larger than the inner diameters of the inner circumferential surfaces 114b and 115b of the first piston ring 114 and the second piston ring 115 at the terminal stage of wear (at an estimated point of time that maximum wear occurs on design) in a natural state where no external force is applied to the first inner contact ring 116 in the radial direction.

The first piston ring 114 and the second piston ring 115 are made of, for example, a resin material, and the first inner contact ring 116 is made of, for example, a metal material. As illustrated in FIG. 3B, a thickness of the first piston ring 114 in the radial direction is indicated by T114, and a thickness of the second piston ring 115 in the radial direction is indicated by T115. The first piston ring 114 and the second piston ring 115 are formed so as to have the same thickness, that is, the thickness T114 and the thickness T115 are the same in a state where neither the first piston ring 114 nor the second piston ring 115 is worn.

On the other hand, the first inner contact ring 116 has a thickness T116 in the radial direction. The thickness T116 of the first inner contact ring 116 is set smaller than the thickness T114 of the first piston ring 114 and the thickness T115 of the second piston ring 115. By setting the thickness T116 of the first inner contact ring 116 small, even when the wear of the first piston ring 114 or the wear of the second piston ring 115 progresses, the first inner contact ring 116 expands in diameter to follow the inner surfaces of the first and second piston rings 114, 115 with high followability. The piston rings 114, 115 receive a pressing force directed outwardly in the radial direction from the first inner contact ring 116, and is kept in contact with the inner circumferential surface 10a of the cylinder 10 until the terminal stage of wear of the piston rings 114, 115.

### 4. Gas Sealing Property of Piston Ring Unit 113

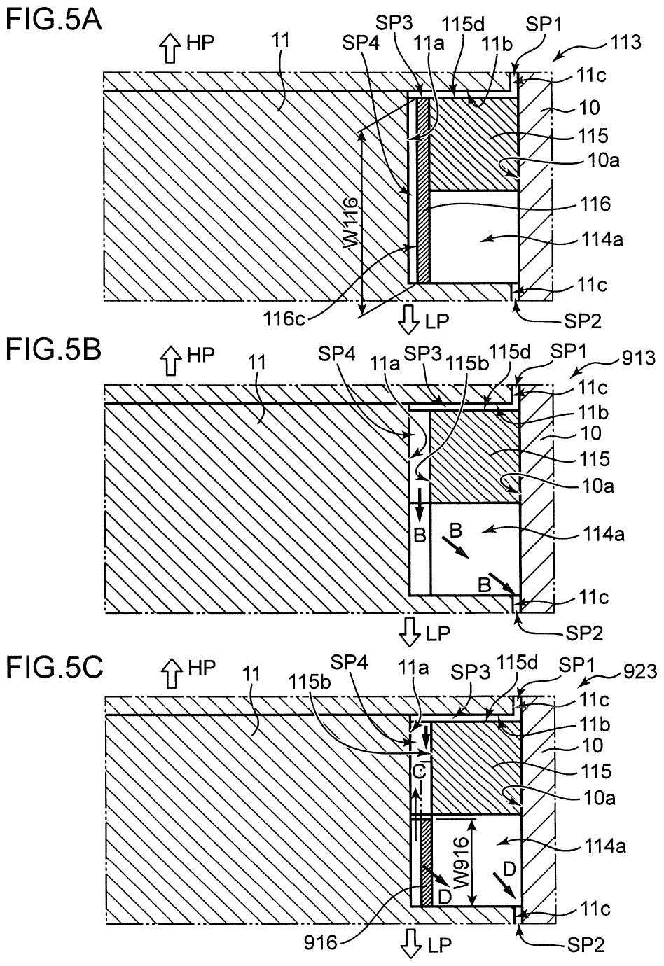

The gas sealing property of the piston ring unit 113 will be described with reference to FIG. 5A, FIG. 5B, and FIG. 5C. FIG. 5A is a cross-sectional view illustrating a partial configuration of the piston ring unit 113 according to the present embodiment, FIG. 5B is a cross-sectional view illustrating the configuration of a portion of a piston ring unit 913 according to a comparative example 1, and FIG. 5C is a cross-sectional view illustrating a partial configuration of a piston ring unit 923 according to a comparative example 2.

As illustrated in FIG. 5A, FIG. 5B, and FIG. 5C, between an outer circumferential surface 11c of a piston 11, excluding a portion where the annular groove 11a is formed, and the inner circumferential surface 10a of the cylinder 10, a gap SP1 is formed on the high-pressure HP side, and a gap SP2 is formed on the low-pressure LP side. The gaps SP1 and SP2 can be reduced by increasing accuracy in manufacturing the cylinder 10 and the piston 11. However, the gaps SP1 and SP2 never fail to be opened for enabling the piston 11 to perform a reciprocating motion in the cylinder 10.

A gap SP3 is also formed between a groove side surface 11b of the annular groove 11a of the piston 11 and an end surface 115d of the second piston ring 115 on the high-pressure HP side. Further, a gap SP4 is formed between a groove bottom surface of the annular groove 11a of the piston 11 and an inner circumferential surface 116c of the first inner contact ring 116 in FIG. 5A, and between the groove bottom surface of the annular groove 11a of the piston 11 and an inner circumferential surface 115b of the second piston ring 115 in FIG. 5B and FIG. 5C.

As illustrated in FIG. 5A, in the piston ring unit 113 according to the present embodiment, the plate width W116 of the first inner contact ring 116 extends from the first piston ring 114 to the second piston ring 115 in the axial direction. Therefore, even if the piston 11 performs a reciprocating motion in the cylinder 10 or even if the deviation of the first inner contact ring 116 in the axial direction is large, the reciprocating motion of the piston 11 is prevented by a distance corresponding to the gap SP3. Therefore, in the piston ring unit 113 according to the present embodiment, it is possible to prevent the formation of a leakage path of a hydrogen gas caused by the connection between the joint 114a of the first piston ring 114 and the gap SP4. Therefore, in the piston ring unit 113 according to the present embodiment, gas leakage from the gap SP1 on the high-pressure HP side to the gap SP2 on the low-pressure LP side is prevented.

On the other hand, as illustrated in FIG. 5B, in the piston ring unit 913 according to the comparative example 1 which does not include the first inner contact ring 116, a state exists where the joint 114a of the first piston ring 114 and the gap SP4 are always connected to each other. That is, a state exists where a leakage path of a hydrogen gas is formed. Therefore, in the piston ring unit 913 according to the comparative example 1, it is difficult to prevent leakage of a hydrogen gas as indicated by an arrow B from the gap SP1 on the high-pressure HP side to the gap SP2 on the low-pressure LP side.

As illustrated in FIG. 5C, in the piston ring unit 923 according to the comparative example 2 which includes a first inner contact ring 916 having a plate width W916 narrower than the plate width W116 of the first inner contact ring 116 and having a thickness smaller than a plate thickness of the first piston ring 114, the first inner contact ring 916 moves as indicated by an arrow C as the piston 11 performs a reciprocating motion. Therefore, in the piston ring unit 923 according to the comparative example 2, the joint 114a of the first piston ring 114 and the gap SP4 are connected to each other along with the reciprocating motion of the piston 11. Accordingly, a leakage path of a hydrogen gas is formed. Therefore, also in the piston ring unit 923 according to the comparative example 2, it is difficult to prevent leakage of a hydrogen gas as indicated by an arrow D from the gap SP1 on the high-pressure HP side to the gap SP2 on the low-pressure LP side.

### 5. Advantageous Effects

In the piston ring unit 113 according to the present embodiment, as described with reference to FIG. 4, as viewed in the radial direction, the first inner contact ring 116 is disposed such that the opening 116a formed in the inner contact ring 116 does not overlap with the joints 114a and 115a of the first piston ring 114 and the second piston ring 115. Therefore, in the piston ring unit 113, it is possible to prevent the connection between the joints 114a, 115a of the piston ring 114, 115 and the opening 116a of the first inner contact ring 116 and hence, leakage of a hydrogen gas is prevented.

In the piston ring unit 113 according to the present embodiment, the first inner contact ring 116 disposed from the first piston ring 114 to the second piston ring 115 in the axial direction is interposed between the groove bottom surface of the annular groove 11a in the piston 11 and the respective inner circumferential surfaces 114b, 115b of the piston rings 114, 115. Therefore, in the piston ring unit 113, even when the piston 11 performs a reciprocating motion in the cylinder 10, displacement of the relative position between the piston rings 114, 115 and the first inner contact ring 116 in the axial direction is prevented. As a result, in the piston ring unit 113, a state where the first inner contact ring 116 is interposed between the groove bottom surface of the annular groove 11a in the piston 11 and the joints 114a, 115a of the piston rings 114, 115 is maintained. Accordingly, leakage of a hydrogen gas from the high-pressure HP side to the low-pressure LP side is prevented.

Therefore, in the piston ring unit 113 according to the present embodiment, it is possible to prevent leakage of a hydrogen gas from the high-pressure HP side to the low-pressure LP side.

In the piston ring unit 113 according to the present embodiment, as illustrated in FIG. 4, the circumferential ends 116d, 116e of the first inner contact ring 116 and the circumferential ends 114f, 115h of the piston rings 114, 115 are circumferentially displaced by approximately ⅛ turn in the circumferential direction. With such a configuration, in the piston ring unit 113, it is possible to prevent the opening 116a of the first inner contact ring 116 and the respective joints 114a, 115a of the piston rings 114, 115 from being connected to each other. Accordingly, length of a path through which a hydrogen gas may leak can be increased. Therefore, in the piston ring unit 113 according to the present embodiment, leakage of hydrogen gas can be prevented.

In the piston ring unit 113 according to the present embodiment, the first inner contact ring 116 has spring characteristics in the radial direction, and the outer diameter of the first inner contact ring 116 in a natural state is set equal to or larger than the inner diameter of the piston ring 114 and the inner diameter of the piston ring 115 when these piston rings 114, 115 expand at maximum. Therefore, in the piston ring unit 113, the first inner contact ring 116 follows the inner circumferential surfaces 114b, 115b of the piston rings 114, 115 until the piston rings 114, 115 expand to a maximum extent. Thus, the leakage of a hydrogen gas from the high-pressure HP side to the low-pressure LP side can be prevented until terminal stage of wear of the piston rings 114, 115.

In the piston ring unit 113 according to the present embodiment, the first piston ring 114, the second piston ring 115, and the first inner contact ring 116 are fitted into the annular groove 11a formed on the piston 11. As described above, by fitting the piston rings 114, 115 and the first inner contact ring 116 in the region defined by the annular groove 11a, a length of the gas leakage path which connects the gap SP1 on the high-pressure HP side and the gap SP2 on the low-pressure LP side to each other can be increased. Accordingly, leakage of a gas (a hydrogen gas) can he prevented.

Furthermore, the reciprocating compressor 1 according to the present embodiment includes the plurality of piston ring units 113 each acquiring the above-described effects. Accordingly, the highly efficient gas compression can he performed by preventing gas (hydrogen gas) leakage.

In the present embodiment, a hydrogen gas is applied as an example of a pressurized fluid. A hydrogen gas has a molecular weight smaller than a molecular weight of air or the like and hence, it is considered that the hydrogen gas may leak from a small gap. However, by adopting the configuration of the piston ring unit 113 according to the present embodiment, gas leakage can be effectively prevented.

### Second Embodiment

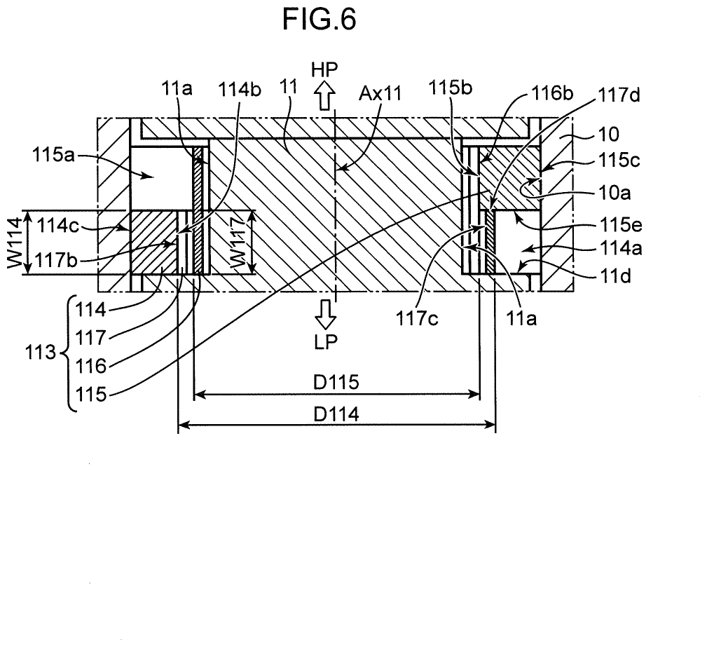

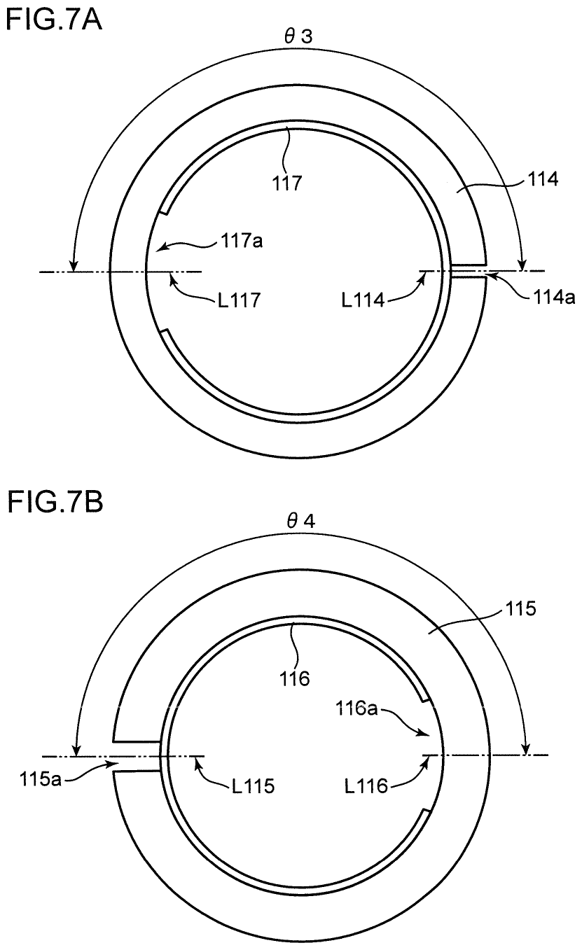

A configuration of a reciprocating compressor 1 according to a second embodiment will be described with reference to FIG. 6, FIG. 7A, and FIG. 7B. The reciprocating compressor 1 according to the present embodiment differs from the reciprocating compressor 1 according to the first embodiment with respect to the configuration of the piston ring unit 113. Therefore, FIG. 6, FIG. 7A, and FIG. 7B illustrate the piston ring unit 113 by which the second embodiment is made different from the first embodiment.

As illustrated in FIG. 6, FIG. 7A and FIG. 7B, the piston ring unit 113 according to the present embodiment includes a second inner contact ring 117 in addition to a first piston ring 114, a second piston ring 115, and a first inner contact ring 116. In the piston ring unit 113 according to the present embodiment, an inner diameter D114 of the first piston ring 114 is set larger than an inner diameter D115 of the second piston ring 115.

The first inner contact ring 116 is disposed such that an outer circumferential surface 116b of the first inner contact ring 116 in contacts with(fit onto) an inner circumferential surface 115b of the second piston ring 115. In the same manner as the first embodiment, the first inner contact ring 116 is disposed with a plate width ranging from the first piston ring 114 to the second piston ring 115 in the axial direction.

On the other hand, the second inner contact ring 117 is formed such that a plate width W117 of the second inner contact ring 117 in the axial direction is equal to or smaller than a thickness W114 of the first piston ring 114 in the axial direction. With such a configuration, the second inner contact ring 117 is disposed such that an outer circumferential surface 117b in contacts with an inner circumferential surface 114b of the first piston ring 114. The second inner contact ring 117 has an end surface 117d on a high-pressure HP side which in contacts with or is disposed close to an end surface 115e of the second piston ring 115 on a low-pressure LP side. That is, the movement of the second inner contact ring 117 in the axial direction is restricted by the end surface 115e of the second piston ring 115 and a groove side surface 11d of an annular groove 11a formed on the low-pressure LP side.

The second inner contact ring 117 is disposed with a slight gap formed between an inner circumferential surface 117c of the second inner contact ring 117 and an outer circumferential surface 116b of the first inner contact ring 116. As a result, it is possible to prevent the second inner contact ring 117 from receiving the interference of a force in the radial direction from the first inner contact ring 116. In the same manner, it is also possible to prevent the first inner contact ring 116 from receiving the interference of a force in the radial direction from the second inner contact ring 117.

As illustrated in FIG. 7A, the first piston ring 114 and the second inner contact ring 117 are disposed such that an joint 114a of the first piston ring 114 and an opening 117a of the second inner contact ring 117 do not overlap with each other in the radial direction. Specifically, an imaginary line L114 which passes through the center of the joint 114a in the circumferential direction of the first piston ring 114 and extends in the radial direction, and an imaginary line L117 which passes through the center of the opening 117a in the circumferential direction of the second inner contact ring 117 and extends in the radial direction are drawn. In this case, the first piston ring 114 and the second inner contact ring 117 are disposed such that an angle θ3 made by the imaginary line L114 and the imaginary line L117 becomes approximately 180°. By setting θ3 to a large angle in this manner, a circumferential distance between the joint 114a of the first piston ring 114 and the opening 117a fowled in the second inner contact ring 117 can be increased. Such an increase of the circumferential distance is advantageous in preventing gas (hydrogen gas) leakage.

As illustrated in FIG. 7B, the second piston ring 115 and the first inner contact ring 116 are disposed such that an joint 115a of the second piston ring 115 and the opening 116a of the first inner contact ring 116 do not overlap with each other in the radial direction. Specifically, a case is considered where an imaginary line L115 which passes through the center of the joint 115a in the circumferential direction of the second piston ring 115 and extends in the radial direction, and an imaginary line L116 which passes through the center of the opening 116a in the circumferential direction of the first inner contact ring 116 and extends in the radial direction are drawn. In this case, the second piston ring 115 and the first inner contact ring 116 are disposed such that an angle θ4 made by the imaginary line L115 and the imaginary line L116 becomes approximately 180°. By setting θ4 to a large angle in this manner, a circumferential distance between the joint 115a of the second piston ring 115 and the opening 116a of the first inner contact ring 116 can be increased. Such an increase of the circumferential distance is advantageous in preventing leakage of a gas (a hydrogen gas).

The first piston ring 114 and the second piston ring 115 are disposed such that the angle made by the imaginary line L114 and the imaginary line L115 becomes approximately 180°. Such a configuration is also advantageous in preventing leakage of a gas (hydrogen gas) between the first piston ring 114 and the second piston ring 115.

By disposing the first piston ring 114, the second piston ring 115, and the second inner contact ring 117 as described above, as illustrated in FIG. 6, the joint 114a of the first piston ring 114 is closed by the second inner contact ring 117, and the joint 115a of the second piston ring 115 is closed by the first inner contact ring 116. The joint 114a of the first piston ring 114 and the joint 115a formed in the second piston ring 115 are disposed such that the joint 114a and the joint 115a do not overlap with each other as viewed in a plan view in the axial direction (a state illustrated in FIG. 7A and FIG. 7B). With such a configuration, in the piston ring unit 113 according to the present embodiment, it is possible prevent leakage of a hydrogen gas from the high-pressure HP side to the low-pressure LP side.

In such a configuration, the second inner contact ring 117 is formed with spring characteristics by which the second inner contact ring 117 is expandable in the radial direction to a diameter larger than the inner diameter of the inner circumferential surface 114b of the first piston ring 114 at the terminal stage of wear (at an estimated point of time that maximum wear occurs on design) in a natural state where no external force is applied to the second inner contact ring 117 in the radial direction.

The piston ring unit 113 and the reciprocating compressor 1 including the piston ring unit 113 according to the present embodiment can acquire the same advantageous effects as the advantageous effects of the piston ring unit 113 and the reciprocating compressor 1 according to the first embodiment.

The piston ring unit 113 according to the present embodiment includes the second inner contact ring 117 which mounts on the inner circumferential surface 114b of the first piston ring 114, and the second inner contact ring 117 is disposed such that the opening 117a of the second inner contact ring 117 does not overlap with the joint 114a of the first piston ring 114 in the radial direction. With such a configuration, in the piston ring unit 113, it is possible to prevent the formation of a gas (hydrogen gas) leakage path between the gap formed between the outer circumferential surface 116b of the first inner contact ring 116 and the inner circumferential surface 117c of the second inner contact ring 117 and the joint 114a formed in the first piston ring 114. Accordingly, the piston ring unit 113 can more effectively prevent gas leakage from the high-pressure HP side to the low-pressure LP side.

In the piston ring unit 113, an inner diameter D114 of the first piston ring 114 is set larger than an inner diameter D115 of the second piston ring 115, and the outer circumferential surface 117b of the second inner contact ring 117 in contacts with the inner circumferential surface 114b of the first piston ring 114. With such a configuration, the second inner contact ring 117 is prevented from being displaced in the axial direction by the end surface 115e of the second piston ring 115 on the low-pressure LP side and the groove side surface 11d of the annular groove 11a formed on the low-pressure LP side. As a result, in the piston ring unit 113, a state in which the second inner contact ring 117 in contacts with the inner circumferential surface 114b of the first piston ring 114 is maintained until the terminal stage of wear of the first piston ring 114. Further, the second inner contact ring 117 has spring characteristics by which the second inner contact ring 117 expands outward in the radial direction. Accordingly, it is possible to continuously bias the first piston ring 114 so as to press the outer circumferential surface 114c against the inner circumferential surface 10a of the cylinder 10.

In the piston ring unit 113 according to the present embodiment, the first piston ring 114 is disposed on the low-pressure LP side. Accordingly, the wear of the first piston ring 114 may progress faster than the wear of the second piston ring 115 disposed on the high-pressure HP side. Therefore, even when the wear of the first piston ring 114 progresses relatively quickly, the second inner contact ring 117 is disposed so as to in contacts with the inner circumferential surface 114b of the first piston ring 114. Accordingly, the sealing property by the first piston ring 114 can be secured until the terminal stage of wear of the first piston ring 14. That is, the first piston ring 114 is elastically biased outwardly in the radial direction by the second inner contact ring 117. Accordingly, the abutment state where the first piston ring 114 mounts on the inner circumferential surface 10a of the cylinder 10 is maintained until the terminal stage of wear and hence, the sealing property by the first piston ring 114 can be secured.

### Third Embodiment

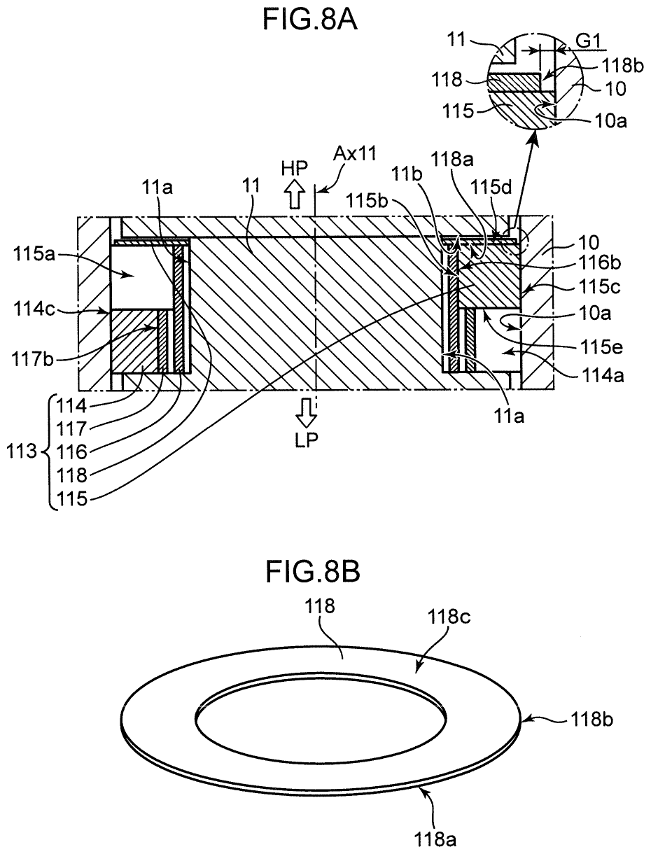

A configuration of a reciprocating compressor 1 according to a third embodiment will be described with reference to FIG. 8A and FIG. 8B. The reciprocating compressor 1 according to the present embodiment differs from the reciprocating compressor 1 according to the first embodiment and the reciprocating compressor 1 according to the second embodiment with respect to the configuration of a piston ring unit 113. Therefore, in FIG. 8A, the piston ring unit 113, which is a portion by which the third embodiment is made different from the first embodiment and the second embodiment is illustrated in an extracted manner. The present embodiment is based on the piston ring unit 113 according to the second embodiment described above. However, the present invention is not limited to such a configuration. Modifications of the third embodiment will be described later.

As illustrated in FIG. 8A, the piston ring unit 113 according to the present embodiment includes an auxiliary ring 118 in addition to a first piston ring 114, a second piston ring 115, a first inner contact ring 116, and a second inner contact ring 117. As illustrated in FIG. 8B, the auxiliary ring 118 is formed of an annular flat plate (for example, a metal plate). That is, as illustrated in FIG. 8A, the auxiliary ring 118 has a cross section in which a size of the auxiliary ring 118 in the axial direction is smaller than a size of the auxiliary ring 118 in the radial direction. As illustrated in an enlarged portion in FIG. 8A, the auxiliary ring 118 is disposed with a slight gap G1 formed between the auxiliary ring 118 and an inner circumferential surface 10a of the cylinder 10.

As illustrated in FIG. 8A, the auxiliary ring 118 is disposed on an end surface 115d of the second piston ring 115 on the high-pressure HP side. In a state where the piston 11 is stationary, one main surface 118a of the auxiliary ring 118 in contacts with an end surface 115d of the second piston ring 115 and an end surface of the first inner contact ring 116 on the high-pressure HP side, and another main surface 118c is disposed with a gap formed between the main surface 118c and a groove side surface 11b of the piston 11.

The auxiliary ring 118 in contacts with or is disposed close to the groove bottom surface of the annular groove 11a, and is disposed so as to cover the high-pressure HP side of the gap between the groove bottom surface of the annular groove 11a and the first inner contact ring 116.

The piston ring unit 113 and the reciprocating compressor 1 including the piston ring unit 113 according to the present embodiment can acquire the same advantageous effects as the advantageous effects of the piston ring units 113 and the reciprocating compressors 1 according to the first embodiment and the second embodiment.

Further, the piston ring unit 113 and the reciprocating compressor 1 according to the present embodiment further include an auxiliary ring 118 which has a flat-plate annular shape but in which an joint is not formed. Accordingly, it is possible to prevent the formation of a leakage path of a hydrogen gas from the high-pressure HP side into the annular groove 11a. Therefore, the piston ring unit 113 and the reciprocating compressor 1 according to the present embodiment are more effective in preventing gas leakage.

### Fourth Embodiment

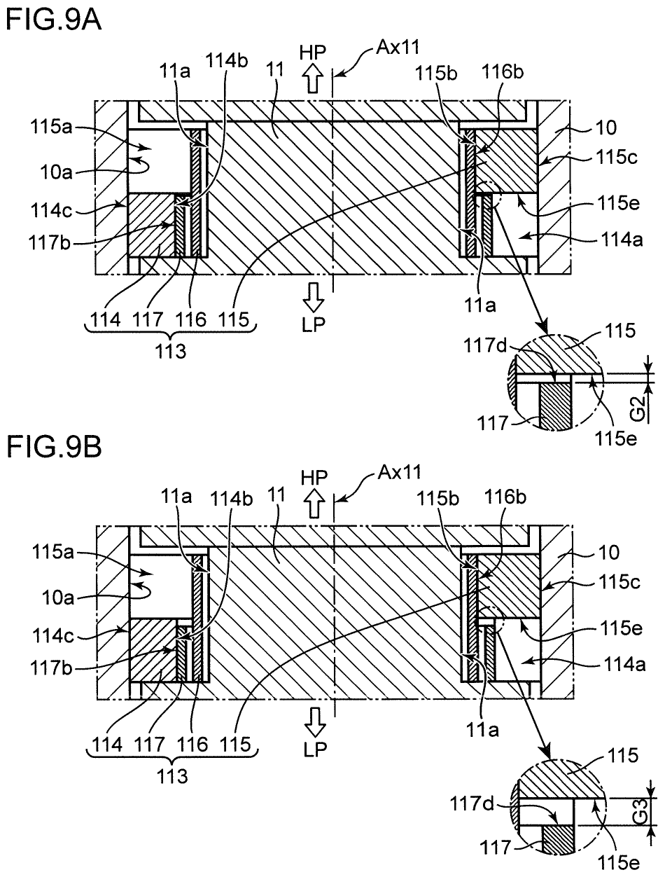

A configuration of a reciprocating compressor 1 according to a fourth embodiment will be described with reference to FIG. 2, FIG. 9A, and FIG. 9B. The reciprocating compressor 1 according to the present embodiment differs from the reciprocating compressor 1 according to the second embodiment with respect to a point that the configuration of the piston ring unit 113 mounted on the piston differs depending on a portion of a piston 11 where the piston ring unit 113 is mounted in an axial direction. Therefore, only portions by which the fourth embodiment is made different from the second embodiment are described.

As illustrated in FIG. 2, a case is considered where the piston 11 is divided into a high-pressure end portion 11h, a low-pressure end portion 11l, and an intermediate portion 11m in the axial direction. In this case, with respect to the piston ring units 113 according to the present embodiment, the piston ring unit 113 mounted on the high-pressure end portion 11h and the piston ring unit 113 mounted on the low-pressure end portion 11l have the configuration different from the configuration of the piston ring unit 113 mounted on an intermediate portion 11m between the high-pressure end portion 11h and the low-pressure end portion 11l.

First, as illustrated in FIGS. 9A and 9B, the piston ring unit 113 according to the present embodiment includes a first piston ring 114, a second piston ring 115, a first inner contact ring 116, and a second inner contact ring 117 in the same manner as the piston ring unit 113 according to the second embodiment. A basic arrangement mode of the first piston ring 114, the second piston ring 115, the first inner contact ring 116, and the second inner contact ring 117 is also substantially equal to the basic arrangement mode of the piston ring unit 113 according to the second embodiment.

Next, as illustrated in an enlarged portion of FIG. 9A, in the piston ring unit 113 mounted on the intermediate portion 11m of the piston 11, a gap G2 is formed between an end surface 117d of the second inner contact ring 117 on the high-pressure HP side and an end surface 115e of the second piston ring 115 on the low-pressure LP side. On the other hand, as illustrated in an enlarged portion of FIG. 9B, in the piston ring unit 113 mounted on the high-pressure end portion 11h and the low-pressure end portion 11l of the piston 11 respectively, a gap G3 which is wider than the gap G2 is formed between the end surface 117d of the second inner contact ring 117 on the high-pressure HP side and the end surface 115e of the second piston ring 115 on the low-pressure LP side. In other words, a width size of the second inner contact ring 117 in the axial direction is set wide with respect to the piston ring unit 113 mounted on the intermediate portion 11m of the piston 11, and is set narrow in the piston ring unit 113 mounted on the high-pressure end portion 11h and the piston ring unit 113 mounted on the low-pressure end portion 11l.

In the present embodiment, the gap G3 formed in the piston ring unit 113 mounted on the high-pressure end portion 11h and the low-pressure end portion 11l of the piston 11 is set wider than the gap G2 formed in the piston ring unit 113 mounted on the intermediate portion 11m. With such a configuration, an amount of gas leakage from the high-pressure HP side to the low-pressure LP side is adjusted. Specifically, in the piston ring unit 113 mounted on the intermediate portion 11m which has the gap G3 wider than the gap G2 formed in the piston ring unit 113 illustrated in FIG. 9A, an amount of gas which passes through the gap G3 and leaks to the joint 114a of the first piston ring 114 is increased. On the other hand, in the piston ring unit 113 mounted on the high-pressure end portion 11h and the low-pressure end portion 11l which has the gap G2 narrower than the gap G3 formed in the piston ring unit 113 illustrated in FIG. 9B, an amount of gas which passes through the gap G2 and leaks to the joint 114a of the first piston ring 114 is decreased.

In the reciprocating compressor 1 having the above-described configuration, an amount of gas leakage is adjusted by changing a width size (a size in an axial direction) of the second inner contact ring 117 depending on the portion of the piston 11 in the axial direction where the piston ring unit 113 is mounted.

Here, in a case where a plurality of piston ring units 113 are mounted on the piston 11, it is also considered that all piston ring units 113 are requested to secure sealing property which is as high as possible.

However, if all piston rings 113 mounted on the piston 11 are configured to ensure sealing property which is as high as possible, a differential pressure generated between the piston ring unit and the piston ring unit disposed on the high-pressure HP side and the piston ring unit disposed on the low-pressure LP side becomes excessively large. Therefore, when such a configuration is adopted, a load is increased and hence, the wear of the piston rings 113, 114 is increased.

On the other hand, in the reciprocating compressor 1 according to the present embodiment, a width size of the second inner contact ring 117 of the piston ring unit 113 mounted on the high-pressure end portion 11h and the low-pressure end portion 11l of the piston 11 is set narrow and hence, an amount of gas leakage is set larger than an amount of gas leakage in the piston ring unit 113 mounted on the intermediate portion 11m. As described above, the wear of the piston rings 114, 115 as the entire compressor can be prevented by making an amount of gas leakage different depending on the portion of the piston 11 where the piston ring unit 113 is mounted in the axial direction.

In the present embodiment, in view of the tendency that a differential pressure becomes large at the high-pressure end portion 11h and the low-pressure end portion 11l of the piston 11, an amount of gas leakage at the piston ring unit 113 mounted on the high-pressure end portion 11h and the low-pressure end portion 11l is increased.

### Fifth Embodiment

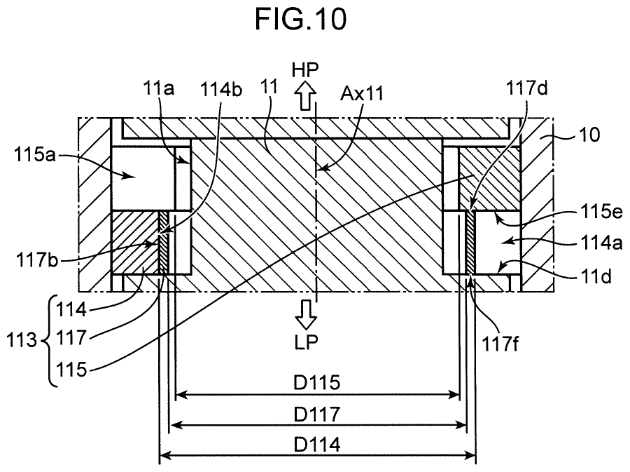

A configuration of a reciprocating compressor 1 according to a fifth embodiment will be described with reference to FIG. 10. The reciprocating compressor 1 according to the present embodiment differs from those of the first embodiment to the third embodiment described above with respect to the configuration of the piston ring unit 113. Therefore, in FIG. 10, the piston ring unit 113, which is a portion by which the fifth embodiment is made different from the first embodiment to the third embodiment is illustrated in an extracted manner. The present embodiment is based on the piston ring unit 113 according to the second embodiment described above. Therefore, the difference between a piston ring unit 113 of the present embodiment and the piston ring unit 113 according to the second embodiment will be mainly described below.

As illustrated in FIG. 10, the piston ring unit 113 according to the present embodiment includes a first piston ring 114, a second piston ring 115, and a second inner contact ring 117. That is, the piston ring unit 113 according to the present embodiment differs from the piston ring unit 113 according to the second embodiment with respect to a point that the first inner contact ring 116 is omitted.

Also in the piston ring unit 113 according to the present embodiment, an inner diameter D114 of the first piston ring 114 is larger than an inner diameter D115 of the second piston ring 115. An inner diameter D117 of the second inner contact ring 117 is set equal to or larger than the inner diameter D115.

The plate width W117 of the second inner contact ring 117 in the axial direction is substantially equal to the plate width W117 of the second inner contact ring 117 in the second embodiment. The second inner contact ring 117 is also substantially equal to the second inner contact ring 117 in the second embodiment also with respect to a point that an outer circumferential surface 117b of the second inner contact ring 117 is disposed such that the outer circumferential surface 117b in contacts with an inner circumferential surface 114b of the first piston ring 114.

With respect to the second inner contact ring 117 according to the present embodiment, an end surface 117d of the second inner contact ring 117 on the high-pressure HP side in contacts with or is disposed close to an end surface 115e of the second piston ring 115 on the low-pressure LP side, and an end surface 117f of the second inner contact ring 117 on the low-pressure LP side in contacts with or is disposed close to a groove side surface 11d of the annular groove 11a on the low-pressure LP side. With such an arrangement, the second inner contact ring 117 according to the present embodiment is also restricted from moving in the axial direction by the end surface 115e of the second piston ring 115 and the groove side surface 11d of the annular groove 11a on the low-pressure LP side.

The piston ring unit 113 and the reciprocating compressor 1 including the piston ring unit 113 according to the present embodiment can acquire the same advantageous effects as the advantageous effects of the piston ring units 113 and the reciprocating compressors 1 according to the first embodiment and the second embodiment.

Further, in the piston ring unit 113 and the reciprocating compressor 1 according to the present embodiment, the number of components can be reduced by an amount corresponding to the omission of the first inner contact ring 116 as compared with the piston ring unit 113 and the reciprocating compressor 1 according to the second embodiment. Accordingly, a manufacturing cost of the piston ring unit 113 and the reciprocating compressor 1 can be reduced.

### Modification 1

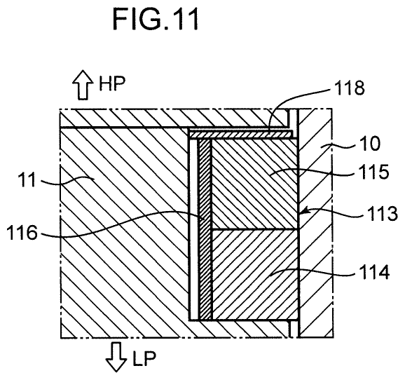

A piston ring unit 113 according to the modification 1 will be described with reference to FIG. 11. The piston ring unit 113 according to the present modification differs from the piston ring unit 113 according to the first embodiment with respect to a point that the auxiliary ring 118 adopted in the third embodiment is disposed. In FIG. 11, a portion of the piston ring unit 113 is illustrated in an extracted manner.

As illustrated in FIG. 11, the piston ring unit 113 according to the present modification includes a first piston ring 114, a second piston ring 115, a first inner contact ring 116, and an auxiliary ring 118. The configuration of the members 114 to 116 is the same as the corresponding configuration of the first embodiment, and the configuration of the auxiliary ring 118 is the same as the corresponding configuration of the third embodiment.

In the piston ring unit 113 according to the present modification, the auxiliary ring 118 is disposed such that the auxiliary ring 118 in contacts with an end surface of the second piston ring 115 and an end surface of the first inner contact ring 116 on the high-pressure HP side in the same manner as the third embodiment.

The piston ring unit 113 and the reciprocating compressor 1 including the piston ring unit 113 according to the present modification can acquire substantially the same advantageous effects as the advantageous effects acquired by the first embodiment. In the present modification, the auxiliary ring 118 is disposed such that the auxiliary ring 118 in contacts with the end surface of the second piston ring 115 on the high-pressure HP side and the end surface of the first inner contact ring 116 on the high-pressure HP side. Accordingly, it is possible to prevent the formation of a gas leakage path from the high-pressure HP side to the low-pressure LP side.

### Modification 2

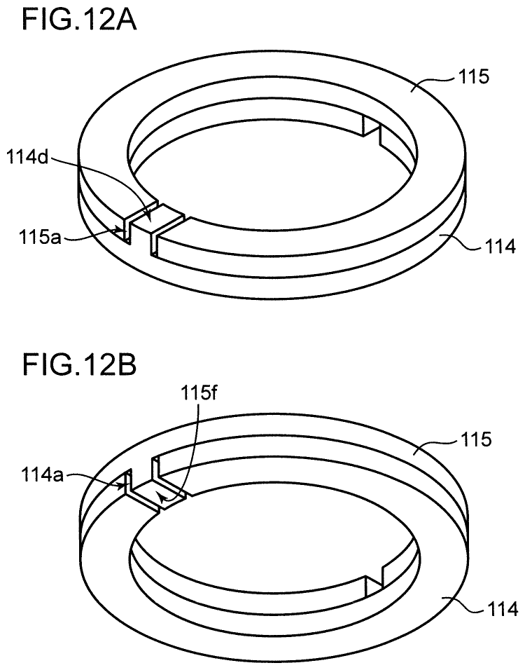

A piston ring unit 113 and a reciprocating compressor 1 including the piston ring unit 113 according to the modification 2 will be described with reference to FIG. 12A. In the present modification, the structure of a first piston ring 114 differs from the structure of the first piston ring 114 in the first embodiment descried above, and the other configurations are substantially equal to the corresponding configurations of the first embodiment described above. Hereinafter, the description will be made by focusing on the configuration of portions which differ from the corresponding portions of the first embodiment.

As illustrated in FIG. 12A, in the piston ring unit 113 according to the present modification, the first piston ring 114 has a protrusion 114d which protrudes toward a high-pressure HP side. The protrusion 114d engages with an joint 115a of the second piston ring 115 when the second piston ring 115 is made to overlap with the first piston ring 114. In the present modification, the engagement between the protrusion 114d and the joint 115a may be made in a state where no gap exists between the protrusion 114d and the joint 115a in the circumferential direction in the circumferential direction, or such engagement may be made in a state where a gap exists between the protrusion 114d and the joint 115a in the circumferential direction.

The piston ring unit 113 and the reciprocating compressor 1 including the piston ring unit 113 according to the present modification can acquire the same advantageous effects as the advantageous effects of the respective piston ring units 113 and the respective reciprocating compressors 1 according to the first embodiment and the second embodiment.

Further, in the piston ring unit 113 and the reciprocating compressor 1 according to the present modification, the first piston ring 114 has the protrusion 114d which engages with the joint 115a formed in the second piston ring 115. Therefore, in the piston ring unit 113 and the reciprocating compressor 1, even if vibration or the like is applied to the piston ring unit 113 when a piston 11 performs a reciprocating motion in a cylinder 10, the relative rotation between the first piston ring 114 and the second piston ring 115 in the circumferential direction can be prevented.

Further, in the piston ring unit 113 according to the present modification, the protrusion 114d of the first piston ring 114 is made to engage with the joint 115a of the second piston ring 115 so as to prevent the rotation between the first piston ring 114 and the second piston ring 115. Therefore, in the piston ring unit 113 according to the present modification, it is not necessary to additionally form a portion for engagement between the first piston ring 114 and the second piston ring 115 on the second piston ring 115. Accordingly, the configuration of the second piston ring 115 can be simplified.

### Modification 3

A piston ring unit 113 and a reciprocating compressor 1 including the piston ring unit 113 according to the modification 3 will be described with reference to FIG. 12B. In the present modification, the structure of a first piston ring 114 differs from the structure of the first piston ring 114 in the first embodiment descried above, and the other configurations are substantially equal to the corresponding configurations of the first embodiment described above. Hereinafter, the description will be made by focusing on the configuration of portions which differ from the corresponding portions of the first embodiment.

As illustrated in FIG. 12B, in the piston ring unit 113 according to the present modification, a second piston ring 115 has a protrusion 115f which protrudes toward a low-pressure LP side. The protrusion 115f engages with an joint 114a of the first piston ring 114 when the first piston ring 114 and the second piston ring 115 are made to overlap with each other. Also in the present modification, the engagement between the protrusion 115f and the joint 114a may be made in a state where no gap exists between the protrusion 115f and the joint 114a in the circumferential direction in the circumferential direction, or such engagement may be made in a state where a gap exists between the protrusion 115f and the joint 114a in the circumferential direction.

The piston ring unit 113 and the reciprocating compressor 1 including the piston ring unit 113 according to the present modification can acquire the same advantageous effects as the advantageous effects of the respective piston ring units 113 and the respective reciprocating compressors 1 according to the first embodiment and the second embodiment.

Further, in the piston ring unit 113 and the reciprocating compressor 1 according to the present modification, the second piston ring 115 has the protrusion 115f which engages with the joint 114a formed in the first piston ring 114. Therefore, in the piston ring unit 113 and the reciprocating compressor 1, even if vibration or the like is applied to the piston ring unit 113 when a piston 11 performs a reciprocating motion in a cylinder 10, the relative rotation between the first piston ring 114 and the second piston ring 115 in the circumferential direction can be prevented.

Further, in the piston ring unit 113 according to the present modification, the protrusion 115f of the second piston ring 115 is made to engage with the joint 114a of the first piston ring 114 so as to prevent the rotation between the first piston ring 114 and the second piston ring 115. Therefore, in the piston ring unit 113 according to the present modification, it is not necessary to additionally form a portion for engagement between the first piston ring 114 and the second piston ring 115 on the first piston ring 114. Accordingly, the configuration of the first piston ring 114 can be simplified.

### Modification 4

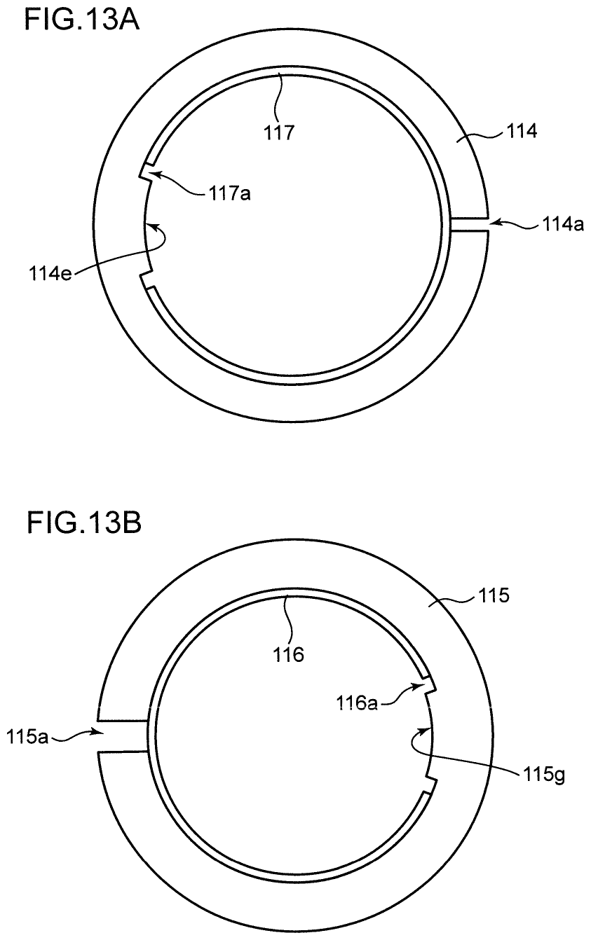

A piston ring unit 113 and a reciprocating compressor 1 including the piston ring unit 113 according to the modification 4 will be described with reference to FIG. 13A. In the present modification, the structure of a first piston ring 114 differs from the structure of the first piston ring 114 in the second embodiment described above, and the other configurations are substantially equal to the corresponding configurations of the second embodiment described above. Hereinafter, the description will be made by focusing on the configuration of portions which differ from the corresponding portions of the second embodiment.

As illustrated in FIG. 13A, in the piston ring unit 113 according to the present modification, the first piston ring 114 has an engaging portion 114e which protrudes inwardly in a radial direction. When a second inner contact ring 117 is in contacted with inside the first piston ring 114, the engaging portion 114e engages with an opening 117a of the second inner contact ring 117. Also in the present modification, the engagement between the engaging portion 114e and the opening 117a may be made in a state where no gap exists between the engaging portion 114e and the opening 117a in the circumferential direction, or such engagement may be made in a state where a gap exists between the engaging portion 114e and the opening 117a in the circumferential direction.

The piston ring unit 113 and the reciprocating compressor 1 including the piston ring unit 113 according to the present modification can acquire the same advantageous effects as the advantageous effects of the piston ring unit 113 and the reciprocating compressor 1 according to the second embodiment.

Further, in the piston ring unit 113 and the reciprocating compressor 1 according ₜo the present modification, the configuration is adopted where the first piston ring 114 has the engaging portion 114e, and the engaging portion 114e engages with the opening 117a formed in the second inner contact ring 117. Therefore, in the piston ring unit 113 and the reciprocating compressor 1 according to the present modification, even if vibration or the like is applied to the piston ring unit 113 when a piston 11 performs a reciprocating motion in a cylinder 10, the relative rotation between the second inner contact ring 117 and the first piston ring 114 in the circumferential direction can be prevented. Accordingly, leakage of a gas can be prevented.

### Modification 5

A piston ring unit 113 and a reciprocating compressor 1 including the piston ring unit 113 according to the modification 5 will be described with reference to FIG. 13B. In the present modification, the structure of a second piston ring 115 differs from the structure of the second piston ring 115 in the second embodiment described above, and the other configurations are substantially equal to the corresponding configurations of the second embodiment described above. Hereinafter, the description will be made by focusing on the configuration of portions which differ from the corresponding portions of the second embodiment.

As illustrated in FIG. 13B, in the piston ring unit 113 according to the present modification, the second piston ring 115 has an engaging portion 115g which protrudes inwardly in a radial direction. When a first inner contact ring 116 is in contacted with inside the second piston ring 115, the engaging portion 115g engages with an opening 116a of the first inner contact ring 116. Also in the present modification, the engagement between the engaging portion 115g and the opening 116a may be made in a state where no gap exists between the engaging portion 115g and the opening 116a in the circumferential direction in the circumferential direction, or such engagement may be made in a state where a gap exists between the engaging portion 115g and the opening 116a in the circumferential direction.

The piston ring unit 113 and the reciprocating compressor 1 including the piston ring unit 113 according to the present modification can acquire the same advantageous effects as the advantageous effects of the piston ring unit 113 and the reciprocating compressor 1 according to the second embodiment.

Further, in the piston ring unit 113 and the reciprocating compressor 1 according to the present modification, the configuration is adopted where the second piston ring 115 has the engaging portion 115g, and the engaging portion 115g engages with the opening 116a of the first inner contact ring 116. Therefore, in the piston ring unit 113 and the reciprocating compressor 1 according to the present modification, even if vibration or the like is applied to the piston ring unit 113 when a piston 11 performs a reciprocating motion in a cylinder 10, the relative rotation between the first inner contact ring 116 and the second piston ring 115 in the circumferential direction can be prevented. Accordingly, leakage of a gas can be prevented.

### Modification 6

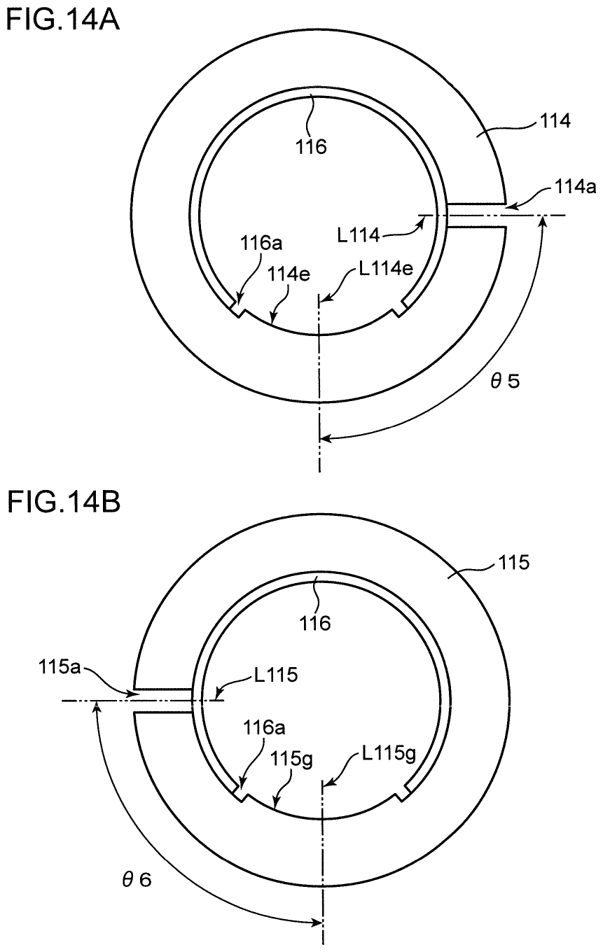

A piston ring unit 113 and a reciprocating compressor 1 including the piston ring unit 113 according to the modification 6 will be described with reference to FIG. 14A and FIG. 14B. The present modification has substantially the same configuration as the first embodiment except for the structure of a first piston ring 114 and the structure of a second piston ring 115. Hereinafter, the description will be made by focusing on the configuration of portions which differ from the corresponding portions of the first embodiment.

First, the structure of the first piston ring 114 will be described with reference to FIG. 14A. As illustrated in FIG. 14A, the first piston ring 114 according to the present modification has an engaging portion 114e which protrudes inwardly in a radial direction. When a first inner contact ring 116 is in contacted with inside the first piston ring 114, the engaging portion 114e engages with an opening 116a formed in a first inner contact ring 116. Also in the present modification, the engagement between the engaging portion 114e and the opening 116a may be made in a state where no gap exists between the engaging portion 114e and the opening 116a in the circumferential direction, or such engagement may be made in a state where a gap exists between the engaging portion 114e and the opening 116a in the circumferential direction.

Here, an imaginary line L114 which passes through the center of an joint 114a in the circumferential direction of the first piston ring 114 and extends in the radial direction, and an imaginary line L114e which passes through the center of the engaging portion 114e in the circumferential direction of the first piston ring 114 and extends in the radial direction are drawn. In this case, an angle θ5 made by the imaginary line L114 and the imaginary line L114e is set to approximately 90°.

Next, the structure of the second piston ring 115 will be described with reference to FIG. 14B. As illustrated in FIG. 14B, the second piston ring 115 according to the present modification has an engaging portion 115g which protrudes inwardly in a radial direction. When a first inner contact ring 116 is in contacted with inside the second piston ring 115, the engaging portion 115g engages with an opening 116a formed in the first inner contact ring 116. Also in this case, the engagement between the engaging portion 115g and the opening 116a may be made in a state where there is no gap exists between the between the engaging portion 115g and the opening 116a in the circumferential direction, or such engagement may be made in a state where a gap exists between the engaging portion 115g and the opening 116a in the circumferential direction.

Here, an imaginary line L115 which passes through the center of an joint 115a in the circumferential direction of the second piston ring 115 and extends in the radial direction, and an imaginary line L115g which passes through the center of the engaging portion 115g in the circumferential direction of the second piston ring 115 and extends in the radial direction are drawn. In this case, an angle θ5 made by the imaginary line L115 and the imaginary line L115g is set to approximately 90°.

Also in the present modification, the first piston ring 114 and the second piston ring 115 are disposed such that the angle made by the imaginary line L114 and the imaginary line L115 becomes approximately 180°.

The piston ring unit 113 and the reciprocating compressor 1 including the piston ring unit 113 according to the present modification can acquire the same advantageous effects as the advantageous effects of the piston ring unit 113 and the reciprocating compressor 1 according to the first embodiment.

In the piston ring unit 113 and the reciprocating compressor 1 according to the present modification, the first piston ring 114 has the engaging portion 114e, and the second piston ring 115 has the engaging portion 115g. The respective engaging portions 114e and 115g adopt the configuration where the respective engaging portions 114e, 115g engage with the opening 116a of the first inner contact ring 116. Therefore, in the piston ring unit 113 and the reciprocating compressor 1 according to the present modification, even if vibration or the like is applied to the piston ring unit 113 when a piston 11 performs a reciprocating motion in a cylinder 10, the relative rotation between the first inner contact ring 116 and the first piston ring 114 and the second piston ring 115 in the circumferential direction can be prevented. Accordingly, gas leakage can be prevented.

### Modification 7

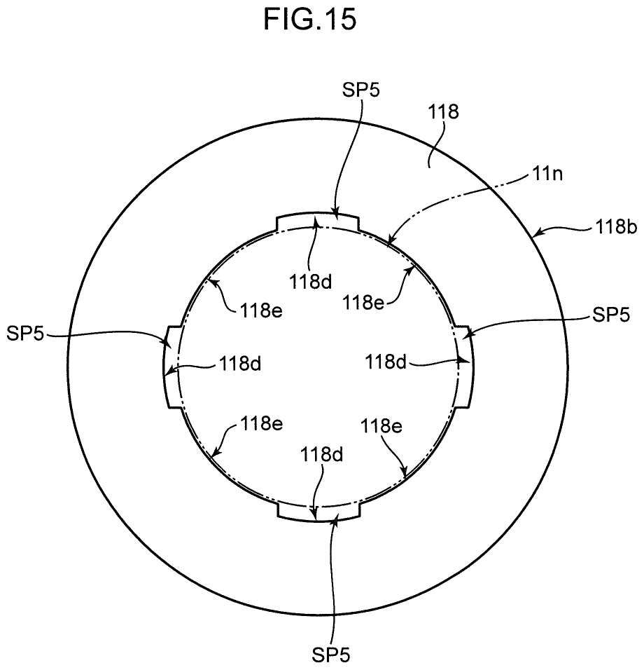

In the third embodiment and the modification 1 described above, the configuration is adopted where the piston ring unit 113 includes the auxiliary ring 118. The present modification differs from the third embodiment described above and the modification 1 described above with respect to the structure of the auxiliary ring 118. Hereinafter, a structure of the auxiliary ring 118 according to the present modification will be described with reference to FIG. 15.

As illustrated in FIG. 15, the auxiliary ring 118 according to the present modification is also formed of an annular flat plate (for example, a metal plate). As illustrated in a plan view of FIG. 15, the auxiliary ring 118 according to the present modification is formed such that an outer circumferential end surface 118b is formed in a circular shape, while an inner circumferential end surface has unevenness in the radial direction. Specifically, the inner circumferential end surface of the auxiliary ring 118 includes recessed portions 118d which is recessed outwardly in the radial direction and protruding portions 118e protruding inwardly in the radial direction.

When the auxiliary ring 118 according to the present modification is in contacted with in the annular groove 11a of the piston 11, the protruding portions 118e in contact with or close to the groove bottom surface 11n of the annular groove 11a, while in the recessed portions 118d, gaps SP5 are formed between the recessed portion 118d and the groove bottom surfaces 11n of the annular grooves 11a. In the present modification, by adopting the auxiliary ring 118 having such a structure, it is possible to allow a gas (hydrogen gas) to flow into gaps SP4 formed between the groove bottom surface 11n of the annular groove 11a and the first inner contact ring 116 or the second inner contact ring 117 through the gaps SP5. Therefore, even if the outer circumferential surfaces 114c, 115c of the piston rings 114, 115 are worn due to the sliding of the piston 11, the diameters of the piston rings 114,115 are enlarged by a pressure of a gas which flows into the gaps SP4.

Therefore, in the piston ring unit 113 and the reciprocating compressor 1 according to the present modification, high sealing property can be secured until the terminal stage of wear of the piston rings 114, 115.

### Other Modifications

In the first to fifth embodiments and the modifications 1 to 7, the piston ring unit 113 which includes two piston rings 114, 115 is adopted. However, the present invention is not limited to such a configuration. For example, it is also possible to adopt a piston ring unit which includes three or more piston rings.

In the fourth embodiment, the configuration is adopted where the piston ring unit 113 illustrated in FIG. 9(a) is mounted on the high-pressure end portion 11h and the low-pressure end portion 11l, and the piston ring unit 113 illustrated in FIG. 9B is mounted on the intermediate portion 11m. However, the present invention is not limited to such a configuration. An amount of gas leakage can be appropriately adjusted corresponding to the magnitude of a differential pressure between the high-pressure side and the low-pressure side of the piston ring unit.

In the first to fifth embodiments and the modifications 1 to 7, a hydrogen gas is employed as an example of a pressurized fluid. However, the present invention is not limited to the use of a hydrogen gas. For example, a fuel gas such as a natural gas, air, or the like can be employed as a pressurized fluid, or liquid such as water can be employed as a pressurized fluid.

When a hydrogen gas is employed as a pressurized fluid, leakage of a hydrogen gas is likely to occur because of a small molecular weight of a hydrogen gas. However, the leakage of a hydrogen gas can be prevented by employing the configurations of the first to fourth embodiments and the modifications 1 to 4.

In the present invention, the configurations of the first to fifth embodiments and the configurations of the modifications 1 to 7 can be appropriately combined with each other. For example, the configuration according to the fifth embodiment may adopt the auxiliary ring 118 according to modification 1 with reference to FIG. 11. Alternatively, the configuration according to the fifth embodiment may adopt the auxiliary ring 118 according to the modification 7 with reference to FIG. 15. Even when the fifth embodiment described above adopts such configurations, the same advantageous effects as described above can be acquired.

In addition, with respect to the configuration according to the fifth embodiment, it is also possible to adopt a configuration in which the protrusion 114d according to the modification 2 described with reference to FIG. 12A is provided, a configuration in which the protrusion 115f according to the modification 3 described with reference to FIG. 12B is provided, or a configuration in which both the protrusion 114d and the protrusion 115f are provided. Even when the fifth embodiment described above adopts such configurations, the same advantageous effects as described above can be acquired.

In addition, the configuration according to the fifth embodiment may also adopt the configuration where the engaging portion 114e described with reference to FIG. 13A is provided or the configuration where the engaging portion 114e described with reference to FIG. 14A is provided. Even when the fifth embodiment described above adopts such configurations, the same advantageous effects as described above can be acquired.

### SUMMARY

A piston ring unit according to one aspect of the present invention is mounted on an outer circumferential surface of a piston which performs a reciprocating motion in a cylinder in a cylinder axis direction of the cylinder. The piston ring unit according to the present aspect includes a plurality of piston rings and an inner contact ring. The plurality of piston rings each have a C-shape as viewed in an axis direction of the piston with a joint at a portion of each of the plurality of piston rings in a circumferential direction, and the plurality of piston rings are mounted on the outer circumferential surface of the piston in a state where the plurality of piston rings are disposed adjacent to each other in an axial direction of the piston and mount on an inner circumferential surface of the cylinder.

The inner contact ring has a C-shape as viewed in the axial direction with an opening in a portion of the inner contact ring in the circumferential direction, is interposed between an outer circumferential surface of the piston and inner circumferential surfaces of the plurality of piston rings, and in contacts with an inner circumferential surface of at least one of the plurality of piston rings.

In the present aspect, the plurality of piston rings are disposed adjacent to each other in axial direction such that the joints of the plurality of piston rings do not overlap with each other in the axial direction. In the present aspect, the inner contact ring is disposed over all of the plurality of piston rings in the axial direction. The inner contact ring is disposed such that the opening does not overlap with the joint of the at least one piston ring as viewed in a radial direction of the piston.

In the piston ring unit according to the aspect, as viewed in the radial direction, the inner contact ring is disposed such that the opening of the inner contact ring does not overlap with the joint of the at least one piston ring. Therefore, in the piston ring unit according to the aspect, the connection between the joint of the at least one piston ring and the opening of the inner contact ring can be prevented and hence, leakage of a pressurized fluid is prevented.

In the piston ring unit according to the aspect, an inner contact ring is interposed between the outer circumferential surface of the piston and the inner circumferential surfaces of the plurality of piston rings over the plurality of piston rings in the axial direction of the piston. Therefore, in the piston ring unit according to the aspect, even when the piston performs a reciprocating motion in the cylinder, displacement of relative positions between the plurality of piston rings and the inner contact ring in the axial direction is prevented. Accordingly, in the piston ring unit according to the aspect, the state in which the inner contact ring is interposed between the outer circumferential surface of the piston and the joint of the at least one piston ring is maintained, and leakage of a pressurized fluid from the high-pressure side to the low-pressure side is prevented.

Therefore, in the piston ring unit according to the aspect, leakage of a pressurized fluid from the high-pressure side to the low-pressure side can be prevented.

In the piston ring unit according to the aspect, the plurality of piston rings may include a first piston ring and a second piston ring, and at least one piston ring may be the second piston ring. An inner diameter of the first piston ring may be larger than an inner diameter of the second piston ring. The inner contact ring is set as a first inner contact ring, a second inner contact ring has a C-shape with an opening in a portion of the second inner contact ring in the circumferential direction and may be interposed between an outer circumferential surface of the first inner contact ring and an inner circumferential surface of the first piston ring in contact with the inner circumferential surface of the first piston ring. The second inner contact ring may be disposed such that the opening of the second inner contact ring and the joint of the first piston ring do not overlap with each other in the radial direction. Further, the second inner contact ring may be expandable in the radial direction of the second inner contact ring following the first piston ring.

The piston ring unit according to the aspect further includes a second inner contact ring which in contacts with the inner circumferential surface of the first piston ring. The second inner contact ring is disposed such that the opening of the second inner contact ring does not overlap with the joint of the first piston ring as viewed in the radial direction. Therefore, in the piston ring unit according to the aspect, the leakage path of a pressurized fluid between the portion on the outer circumferential surface side of the piston with respect to the second inner contact ring and the joint of the first piston ring is blocked. Therefore, in the piston ring unit according to the aspect, leakage of a pressurized fluid from the high-pressure side to the low-pressure side can be further prevented.

In the piston ring unit according to the aspect, the inner diameter of the first piston ring is larger than the inner diameter of the second piston ring, and the second inner contact ring mounts on the inner circumferential surface of the first piston ring. Therefore, the second inner contact ring is prevented from being displaced in the axial direction on one axial end surface of the second piston ring. Thus, in the piston ring unit according to the aspect, a biasing force directed outwardly in the radial direction can be continuously applied by the second inner contact ring until the terminal stage of wear of the first piston ring.

The piston ring unit according to the aspect is effective when the wear of the first piston ring is relatively fast in a case where the outer circumferential surfaces of the first piston ring and the second piston ring wear as the piston performs a reciprocating motion in the cylinder. That is, the wear of the first piston ring and the wear of the second piston ring differ depending on whether the first piston ring is disposed on the high-pressure side or the low-pressure side. When the wear of the first piston ring is faster than the wear of the second piston ring, it is possible to adopt the aspect in which the second inner contact ring that mounts on the inner circumferential surface of the first piston ring and that is expandable in diameter following the first piston ring is disposed. As a result, the outer circumferential surface of the first piston ring can be pressed against the inner circumferential surface of the cylinder until the terminal stage of wear of the first piston ring, and the sealing property can be secured until the terminal stage of wear.

With respect to the piston ring unit according to the aspect, the second inner contact ring may be disposed such that the opening of the second inner contact ring and the opening of the first inner contact ring do not overlap with each other as viewed in the radial direction.

In the piston ring unit according to the aspect, when the second inner contact ring and the first piston ring are viewed in the radial direction, the opening of the second inner contact ring does not overlap with the joint of the first piston ring. Therefore, it is possible to prevent the formation of a leakage path of a pressurized fluid by the opening formed in the second inner contact ring and the joint of the first piston ring.

In the piston ring unit according to the aspect, a size of the second inner contact ring in the axial direction may be set smaller than a size of the first piston ring in the axial direction.

In the piston ring unit according to the aspect, the size of the second inner contact ring in the axial direction is set smaller than the size of the first piston ring in the axial direction and hence, a portion of a pressurized fluid can be made to leak from the gap formed between the second inner contact ring and the second piston ring to the joint of the first piston ring. Therefore, by adopting the piston ring unit according to the aspect as a portion of the plurality of piston ring units mounted on the outer circumferential surface of the piston, an amount of leakage of a pressurized fluid can be adjusted.

However, in mounting a plurality of piston ring units on the piston in the reciprocating compressor, if all piston ring units mounted on the piston are configured to ensure sealing property which is as high as possible, a differential pressure generated between the piston ring unit and the piston ring unit disposed on the high-pressure side and piston ring unit disposed on the low-pressure side becomes excessively large. In this ease, a load is increased and hence, the wear of the piston ring is increased.

Based on such finding, by adopting the piston ring unit according to the aspect as at least one of the plurality of piston ring units mounted on the outer circumferential surface of the piston, an amount of leakage of a pressurized fluid in the entire compressor can be adjusted and hence, the wear of the piston ring can be prevented.

With respect to the high-pressure end and the low-pressure end of the piston, there is a tendency that a differential pressure between the high-pressure side and the low-pressure side of the piston ring unit becomes large. In consideration of such a tendency, by mounting the piston ring units according to the aspect as the piston ring units mounted on the high-pressure end and the low-pressure end of the piston, an amount of wear of the piston ring at the high-pressure end and the low-pressure end can be reduced as a whole piston ring unit.

In the piston ring unit according to the aspect, the first piston ring may have an engaging portion which engages with the opening of the second inner contact ring in the circumferential direction.

In the piston ring unit according to the aspect, the first piston ring has the engaging portion. Accordingly, even if vibration or the like is applied to the piston ring unit when the piston performs a reciprocating motion in the cylinder, the relative rotation between the second inner contact ring and the first piston ring in the circumferential direction can be prevented. Therefore, when the first piston ring and the second inner contact ring are viewed in the radial direction, it is possible to prevent the joint of the first piston ring and the opening of the second inner contact ring from overlapping with each other. Accordingly, leakage of a pressurized fluid can be more suitably prevented.

Further, in the piston ring unit according to the aspect, the engaging portion of the first piston ring is made to engage with the opening of the second inner contact ring. Accordingly, it is not necessary to additionally form a portion for engagement with the first piston ring on the second inner contact ring and hence, the configuration of the second inner contact ring can be simplified.

In the piston ring unit according to the aspect, the first inner contact ring may have spring characteristics which enables the first inner contact ring to expand in diameter in the radial direction of the first inner contact ring. Further, an outer diameter of the first inner contact ring in a natural state where the first inner contact ring does not receive an external force in the radial direction may be equal to or larger than an inner diameter of the second piston ring at the time of maximum expansion when the second piston ring is worn to a maximum extent.

Further, the second inner contact ring may have spring characteristics which enable the second inner contact ring to expand in diameter in the radial direction of the second inner contact ring. Further, an outer diameter of the second inner contact ring in a natural state where the second inner contact ring does not receive an external force in the radial direction may be equal to or larger than an inner diameter of the first piston ring at the time of maximum expansion when the first piston ring is worn to a maximum extent.

In the piston ring unit according to the aspect, the outer diameter of the first inner contact ring in the natural state is equal to or larger than the inner diameter of the second piston ring at the time of maximum expansion. Therefore, in the piston ring unit according to the aspect, the sealing property between the inner circumferential surface of the cylinder and the outer circumferential surface of the second piston ring can be ensured until the second piston ring is expanded to a maximum extent in design.

In the piston ring unit according to the aspect, the outer diameter of the second inner contact ring in the natural state is equal to or larger than the inner diameter of the first piston ring at the time of maximum expansion. Therefore, in the piston ring unit according to the aspect, the sealing property between the inner circumferential surface of the cylinder and the outer circumferential surface of the first piston ring can be secured until the first piston ring is expanded to a maximum extent in design.

In the piston ring unit according to the aspect, the piston may have an annular groove recessed inwardly in the radial direction and annularly provided in the circumferential direction. The plurality of piston rings and the inner contact rings may be fitted in the annular groove. The outer circumferential surface of the piston may form the groove bottom surface of the annular groove.

In the piston ring unit according to the aspect, a plurality of piston rings and an inner contact ring are fitted in the annular groove formed on the piston. The plurality of piston rings and the inner contact ring are fitted in the annular groove in this manner, and thus a length of a leakage path of a pressurized fluid in the axial direction (from the high-pressure side to the low-pressure side) can be increased. Accordingly, leakage of a pressurized fluid can be prevented more suitably.

According to another aspect of the present invention, a piston ring unit is mounted on a piston which performs a reciprocating motion in the cylinder in a cylinder axis direction of the cylinder. The piston has an annular groove which is recessed inwardly in a radial direction and is formed annularly in a circumferential direction. The piston ring unit according to the present aspect includes a plurality of piston rings and an inner contact ring.

The plurality of piston rings each have a C-shape as viewed in an axis direction of the piston with a joint at a portion of each of the plurality of piston rings in a circumferential direction. Further, the plurality of piston rings are mounted on a groove bottom surface of the annular groove of the piston in a state where the plurality of piston rings are disposed adjacent to each other in the axial direction, and mount on an inner circumferential surface of the cylinder.

The inner contact ring has a C-shape as viewed in the axial direction with an opening in a portion of the inner contact ring in the circumferential direction, and is interposed between the groove bottom surface of the piston and an inner circumferential surface of at least one piston ring among the plurality of piston rings. The inner contact ring in contacts with the inner circumferential surface of the at least one piston ring.

In the present aspect, the plurality of piston rings are disposed such that the joints of the plurality of piston rings disposed adjacent to each other in the axial direction in a plan view as viewed in the axial direction do not overlap with each other. The inner contact ring is disposed over the at least one piston ring in the axial direction. Further, the inner contact ring is disposed such that the opening does not overlap with all joints of at least one piston ring as viewed in a radial direction which is orthogonal to the axial direction.

A side at which a pressure boosting chamber is formed in the cylinder is set as a high-pressure side, and a side opposite to the high-pressure side is set as a low-pressure side in the axial direction. The at least one piston ring is disposed closer to the low-pressure side than remaining piston rings in the plurality of piston rings, and an inner diameter of the at least one piston ring is larger than an inner diameter of the piston ring adjacent to the at least one piston ring on the high-pressure side. In the present aspect, the inner contact ring is configured such that an end surface of the inner contact ring on the high-pressure side in contacts with or closes to the piston ring disposed adjacent to the high-pressure side, and an end surface of the inner contact ring on the low-pressure side in contacts with or closes to a groove side surface of the annular groove.

In the piston ring unit according to the aspect, the inner contact ring is disposed such that the opening of the inner contact ring does not overlap with the joint of the at least one piston ring as viewed in the radial direction. Therefore, in the piston ring unit according to the aspect, the connection between the respective joints of the at least one piston ring disposed on the high-pressure side and the opening the inner contact ring can be prevented and hence, leakage of a pressurized fluid is prevented.

Further, in the piston ring unit according to the aspect, the plurality of piston rings are disposed such that the joints do not overlap with each other between the adjacent piston rings. Therefore, it is possible to prevent leakage of a pressurized fluid between the joints disposed adjacent to each other.

In the piston ring unit according to the aspect, an end surface of the inner contact ring on the high-pressure side in contacts with or disposed close to the piston ring disposed adjacent to the inner contact ring, and an end surface of the inner contact ring on the low-pressure side in contacts with or disposed close to a groove side surface of the annular groove. Therefore, in the piston ring unit according to the aspect, even when the piston performs a reciprocating motion in the cylinder, the displacement of the relative position between at least one piston ring and the inner contact ring in the axial direction is prevented. Accordingly, in the piston ring unit according to the aspect, the state in which the inner contact ring is interposed between the groove bottom surface of the annular groove and the joint of the at least one piston ring is maintained, and leakage of a pressurized fluid from the high-pressure side to the low-pressure side is prevented.

Therefore, in the piston ring unit according to the aspect, leakage of a pressurized fluid from the high-pressure side to the low-pressure side can be prevented.

In the piston ring unit according to the aspect, at least one piston ring may have an engaging portion which engages with the opening formed in the inner contact ring in the circumferential direction.

In the piston ring unit according to the aspect, the at least one piston ring has the engaging portion. Accordingly, even if vibration or the like is applied to the piston ring unit when the piston performs a reciprocating motion in the cylinder, the relative rotation between the inner contact ring and the at least one piston ring in the circumferential direction can be prevented. Therefore, as viewed in the radial direction, it is possible to prevent the joint of the at least one piston ring and the opening of the inner contact ring from overlapping with each other. Accordingly, the piston ring unit is more suitable for preventing leakage of a pressurized fluid.

In the piston ring unit according to the aspect, the engaging portion of the at least one piston ring is made to engage with the opening of the inner contact ring. Accordingly, it is not necessary to additionally form a portion for engagement with the at least one piston ring on the inner contact ring and hence, the configuration of the inner contact ring can be simplified.

In the piston ring unit according to the aspect, at least one of the plurality of piston rings may have a protrusion which engages with the joint of a piston ring adjacent to the piston ring in the axial direction.

In the piston ring unit according to the aspect, the at least one piston ring has a protrusion which engages with an joint of a piston ring adjacent to the piston ring in the axial direction. Therefore, in the piston ring unit according to the aspect, even if vibration or the like is applied to the piston ring unit when the piston performs a reciprocating motion in the cylinder, it is possible to prevent the relative rotation in a circumferential direction between the at least one piston ring and the piston ring adjacent to the piston ring in the axial direction. As a result, it is possible to prevent the joint of the at least some piston rings and the joint of the adjacent piston ring described above from overlapping with each other in a plan view as viewed in the axial direction.

In the piston ring unit according to the configuration, the protrusion of the at least one piston ring is made to engage with the joint of the adjacent piston ring in order to prevent the relative rotation of the at least one piston ring and the adjacent piston ring. Therefore, in the piston ring unit according to the aspect, it is not necessary to additionally form a portion for engagement between the at least one piston ring and the adjacent piston ring on the adjacent piston ring. Accordingly, the configuration of the adjacent piston rings can be simplified.

It is needless to say that the configuration is adopted where a protrusion is formed on both of the at least one piston ring and the adjacent piston ring, and the protrusions are made to engage with the joints of the adjacent piston rings to each other.

The piston ring unit according to the aspect may further include an auxiliary ring. Assuming a side on which the pressure boosting chamber is formed in the cylinder in the axial direction as a high-pressure side and a side opposite to the high-pressure side in the axial direction as a low-pressure side, the auxiliary ring is disposed in contacts with high-pressure side with respect to the piston ring disposed at an end on the high-pressure side in the axial direction among the plurality of piston rings, and has an annular shape and is disposed such that a gap is formed between an outer circumferential surface of the auxiliary ring and an inner circumferential surface of the cylinder.

The piston ring unit according to the aspect further includes the auxiliary ring. With the provision of the auxiliary ring, the formation of a leakage path of a pressurized fluid in the axial direction is prevented. Accordingly, the leakage of the pressurized fluid can be more effectively prevented.

In the piston ring unit according to the aspect, an outer circumferential surface of the auxiliary ring does not come into contact with the inner circumferential surface of the cylinder. Accordingly, the auxiliary ring does not generate resistance when the piston performs a reciprocating motion in the cylinder.

The auxiliary ring is disposed in contacts with a surface on the high-pressure side of the piston ring disposed at an end on the high-pressure side in the axial direction among the plurality of piston rings. Accordingly, the auxiliary ring effectively functions to prevent the leakage of a pressurized fluid.

In the piston ring unit according to the aspect, the inner circumferential surface of he auxiliary ring may have a recessed portion which is recessed outwardly in the radial direction in a portion of the inner circumferential surface in the circumferential direction.

In the piston ring unit according to the aspect, the recessed portion is formed in a portion of the inner circumferential surface of the auxiliary ring in the circumferential direction. Therefore, the pressurized fluid can flow between the inner circumferential surfaces of the plurality of piston rings and the outer circumferential surface of the piston through the recessed portion. Therefore, even when the outer circumferential surface of the piston ring is worn due to the reciprocating motion of the piston in the cylinder, the piston ring receives a pressure of a pressurized fluid flowing into the piston ring so that the piston expands in diameter. Therefore, the piston ring unit according to the aspect can ensure high sealing property until the terminal stage of wear of the piston ring.

A compressor according to one aspect of the present invention includes: a cylinder; a piston configured to reciprocate in the cylinder in a cylinder axis direction of the cylinder; and a piston ring unit according to any one of the aspects which is mounted on an outer circumferential surface of the piston.

In the compressor according to the aspect, the piston ring unit according to any one of the aspects is mounted on the outer circumferential surface of the piston. Therefore, the compressors according to the aspects can achieve substantially the same advantageous effects as any of the piston ring units described above.

As has been described above, in the piston ring units and the compressors according to the aspects described above, the leakage of a pressurized fluid from the high-pressure side to the low-pressure side of the piston ring unit can be prevented.

This application is based on Japanese Patent Application No. 2020-213063 filed on Dec. 23, 2020, the contents of which are hereby incorporated by reference.

Although the present invention has been fully described by way of example with reference to the accompanying drawings, it is to be understood that various change and modifications will be apparent to those skilled in the art. Therefore, unless otherwise such changes and modifications depart from the scope of the present invention hereinafter defined, they should be construed as being included therein.

1. A piston ring unit mounted on an outer circumferential surface of a piston which performs a reciprocating motion in a cylinder in a cylinder axis direction of the cylinder, the piston ring unit comprising:
a plurality of piston rings each having a C-shape with a joint at a portion of each of the plurality of piston rings in a circumferential direction, the plurality of piston rings being mounted on the outer circumferential surface of the piston in a state where the plurality of piston rings are disposed adjacent to each other in an axial direction of the piston, and mount on an inner circumferential surface of the cylinder; and
an inner contact ring having a C-shape as viewed in the axial direction with an opening in a portion of the inner contact ring in the circumferential direction, the inner contact ring being interposed between the outer circumferential surface of the piston and inner circumferential surfaces of the plurality of piston rings in contact with an inner circumferential surface of at least one of the plurality of piston rings,
wherein
the plurality of piston rings are disposed adjacent to each other in the axial direction such that the joints of the plurality of piston rings do not overlap with each other in the axial direction, and
the inner contact ring is disposed over all of the plurality of piston rings in the axial direction, and is disposed such that the opening does not overlap with the joint of the at least one piston ring as viewed in a radial direction of the piston.

2. The piston ring unit according to claim 1, wherein
the plurality of piston rings includes a first piston ring and a second piston ring,
the at least one piston ring is the second piston ring,
an inner diameter of the first piston ring is larger than an inner diameter of the second piston ring,
the inner contact ring is set as a first inner contact ring,
a second inner contact ring having a C-shape with an opening in a portion of the second inner contact ring in the circumferential direction and is interposed between an outer circumferential surface of the first inner contact ring and an inner circumferential surface of the first piston ring in contact with the inner circumferential surface of the first piston ring, and
the second inner contact ring is disposed such that the opening of the second inner contact ring and the joint of the first piston ring do not overlap with each other as viewed in the radial direction, and is expandable in the radial direction of the second inner contact ring following the first piston ring.

3. The piston ring unit according to claim 2, wherein
the second inner contact ring is disposed such that the opening of the second inner contact ring does not overlap with the opening of the first inner contact ring as viewed in the radial direction.

4. The piston ring unit according to claim 2, wherein
a size of the second inner contact ring in the axial direction is smaller than a size of the first piston ring in the axial direction.

5. The piston ring unit according to claim 2, wherein
the first piston ring has an engaging portion which, in the circumferential direction, engages with the opening of the second inner contact ring.

6. The piston ring unit according to claim 2, wherein
the first inner contact ring has spring characteristics capable of expanding the first inner contact ring in diameter in a radial direction of the first inner contact ring, and an outer diameter of the first inner contact ring in a natural state where the first inner contact ring does not receive an external force in the radial direction is equal to or larger than an inner diameter of the second piston ring at a time of maximum expansion when the second piston ring is worn to a maximum extent, and
the second inner contact ring has spring characteristics capable of expanding the second inner contact ring in diameter in the radial direction of the second inner contact ring, and an outer diameter of the second inner contact ring in a natural state where the second inner contact ring does not receive an external force in the radial direction is equal to or larger than an inner diameter of the first piston ring at a time of maximum expansion when the first piston ring is worn to a maximum extent.

7. The piston ring unit according to claim 1, wherein
the piston has an annular groove which is recessed inwardly in the radial direction and is annularly formed in a circumferential direction,
the plurality of piston rings and the inner contact ring are fitted in the annular groove, and
the outer circumferential surface of the piston forms a groove bottom surface of the annular groove.

8. The piston ring unit according to claim 1, wherein
the at least one piston ring has an engaging portion which, in the circumferential direction, engages with the opening formed in the inner contact ring.

9. The piston ring unit according to claim 1, wherein
at least one of the plurality of piston rings has a protrusion which engages with the joint formed in a piston ring adjacent to at least one of the plurality of the piston rings in the axial direction.

10. The piston ring unit according to claim 1, further comprising an auxiliary ring, wherein
in a state where a side on which a pressure boosting chamber is formed in the cylinder is set as a high-pressure side and a side opposite to the high-pressure side is set as a low-pressure side in the axial direction, and
the auxiliary ring is disposed in contact with a surface on the high-pressure side of a piston ring disposed at an end on the high-pressure side in the axial direction among the plurality of piston rings, and has an annular shape and is disposed such that a gap is formed between an outer circumferential surface of the auxiliary ring and an inner circumferential surface of the cylinder.

11. The piston ring unit according to claim 10, wherein
an inner circumferential surface of the auxiliary ring has a recessed portion which is recessed outwardly in the radial direction in a portion of the auxiliary ring in the circumferential direction.

12. A piston ring unit mounted on a piston which performs a reciprocating motion in a cylinder in a cylinder axis direction of the cylinder, wherein
the piston has an annular groove which is recessed inwardly in a radial direction and is formed annularly in a circumferential direction,
the piston ring unit comprising:
a plurality of piston rings each having a C-shape with an joint at a portion of each of the plurality of piston rings in a circumferential direction, the plurality of piston rings being mounted on a groove bottom surface of the annular groove of the piston in a state where the plurality of piston rings are disposed adjacent to each other in an axial direction of the piston, mount on an inner circumferential surface of the cylinder; and
an inner contact ring having a C-shape as viewed in the axial direction with an opening in a portion of the inner contact ring in the circumferential direction, the inner contact ring being interposed between the groove bottom surface of the piston and an inner circumferential surface of at least one piston ring among the plurality of piston rings and in contact with the inner circumferential surface of the at least one piston ring,
wherein
the plurality of piston rings are disposed adjacent to each other in the axial direction such that the joints of the plurality of piston rings do not overlap with each other in the axial direction ,
the inner contact ring is disposed over the at least one piston ring in the axial direction, and is disposed such that the opening does not overlap with all joints of the at least one piston ring as viewed in a radial direction of the piston,
in a state where a side at which a pressure boosting chamber is foil led in the cylinder is set as a high-pressure side and a side opposite to the high-pressure side is set as a low-pressure side in the axial direction, the at least one piston ring is disposed closer to the low-pressure side than remaining piston rings in the plurality of piston rings, and an inner diameter of the at least one piston ring is set larger than an inner diameter of the piston ring adjacent to the at least one piston ring on the high-pressure side, and
the inner contact ring is configured such that an end surface of the inner contact ring on the high-pressure side in contacts with or closes to the piston ring disposed adjacent to the high-pressure side, and an end surface of the inner contact ring on the low-pressure side in contacts with or closes to a groove side surface of the annular groove.

13. The piston ring unit according to claim 12, wherein
the at least one piston ring has an engaging portion which, in the circumferential direction, engages with the opening of the inner contact ring.

14. The piston ring unit according to claim 12, wherein
at least one piston ring among the plurality of piston rings has a protrusion which engages with the joint of a piston ring disposed adjacent to the at least one piston ring in the axial direction.

15. The piston ring unit according to claim 12, further comprising an auxiliary ring, wherein
in a state where a side at which a pressure boosting chamber is formed in the cylinder is set as a high-pressure side and a side opposite to the high-pressure side is set as a low-pressure side in the axial direction,
the auxiliary ring is disposed in contacts with a surface on the high-pressure side of the piston ring disposed at an end on the high-pressure side in the axial direction among the plurality of piston rings, and has an annular shape and is disposed such that a gap is formed between an outer circumferential surface of the auxiliary ring and an inner circumferential surface of the cylinder.

16. The piston ring unit according to claim 15, wherein
an inner circumferential surface of the auxiliary ring has a recessed portion which is recessed outwardly in a radial direction in a portion of the auxiliary ring in a circumferential direction.

17. A compressor comprising:
a cylinder;
a piston configured to reciprocate in the cylinder in a cylinder axis direction of the cylinder; and
the piston ring unit according to claim 1 which is mounted on an outer circumferential surface of the piston.

18. A compressor comprising:
a cylinder;
a piston configured to reciprocate in the cylinder in a cylinder axis direction of the cylinder; and
the piston ring unit according to claim 12 which is mounted on an outer circumferential surface of the piston.
